(19) United States
(12) Patent Application Publication
(10) Pub. No.: US 2025/0303697 A1
(43) Pub. Date: Oct. 2, 2025

(54) HEAD UNIT

(71) Applicant: SEIKO EPSON CORPORATION, Tokyo (JP)

(72) Inventors: Tomonori YAMADA, Shiojiri (JP); Toru MATSUYAMA, Matsumoto (JP)

(21) Appl. No.: 19/090,645

(22) Filed: Mar. 26, 2025

(30) Foreign Application Priority Data
Mar. 28, 2024 (JP) 2024-053210

(51) Int. Cl. B41J 2/045

(52) U.S. Cl. CPC B41J 2/04563; B41J 2/0451; B41J 2/04541; B41J 2/04581

(57) ABSTRACT

A head unit includes a plurality of temperature detection circuits including a first temperature detection circuit that detects presence or absence of temperature abnormality and a second temperature detection circuit that detects presence or absence of temperature abnormality, an integrated information output circuit outputting a first temperature abnormality information signal, an individual information output circuit outputting a second temperature abnormality information signal, a temperature information output circuit outputting a temperature abnormality information signal, and one temperature information output terminal outputting a temperature information signal.

The present application is based on, and claims priority from JP Application Serial Number 2024-053210, filed Mar. 28, 2024, the disclosure of which is hereby incorporated by reference herein in its entirety.

### BACKGROUND

### 1. Technical Field

The present disclosure relates to a head unit.

### 2. Related Art

Most of print heads ejecting ink in liquid ejection apparatuses are configured to detect whether abnormality such as temperature abnormality occurs in the print head and output a detection result to the outside of the print head for ensuring quality and safety. For example, JA-A-2004-090501 discloses a technique for detecting whether temperature abnormality occurs in a semiconductor element for operating a drive element of a print head.

JP-A-2004-090501 is an example of the related art.

In recent years, the liquid ejection apparatuses have been widely used in commercial and industrial fields. In the liquid ejection apparatus used the commercial and industrial fields, the number of nozzles ejecting liquid is larger for improving productivity, and as a result, the number of print heads provided in the liquid ejection apparatus is rapidly increased. For application of the technique described in JP-A-2004-090501 to the liquid ejection apparatus and detection of the presence or absence of abnormality such as temperature abnormality occurring in each of the plurality of print heads, the number of signal lines that transmit information on the presence or absence of the abnormality is increased. On the other hand, when abnormality information from output the respective plurality of print heads is integrated using the technique described in JP-A-2004-090501 and transmitted using one signal, it is difficult to specify the print head in which abnormality occurs.

That is, in the head unit having the plurality of print heads, only the technique described in JP-A-2004-090501 is insufficient for detecting abnormality of the plurality of print heads, and there is room for improvement.

### SUMMARY

A head unit according to an aspect of the present disclosure includes a plurality of ejection units including a first ejection unit that contains a first drive element and ejects a liquid by driving the first drive element, and a second ejection unit that contains a second drive element and ejects the liquid by driving the second drive element, a plurality of drive control circuits including a first drive control circuit that controls driving of the first drive element and a second drive control circuit that controls driving of the second drive element, a plurality of temperature detection circuits including a first temperature detection circuit that detects presence or absence of temperature abnormality of the first drive control circuit and a second temperature detection circuit that detects presence or absence of temperature abnormality of the second drive control circuit, an integrated information output circuit outputting a first temperature abnormality information signal according to a plurality of detection results detected by the plurality of temperature detection circuits, an individual information output circuit outputting a second temperature abnormality information signal according to a selected detection result obtained by selecting one from the plurality of detection results in response to a selection signal, a temperature information output circuit outputting a temperature abnormality information signal corresponding to the first temperature abnormality information signal, the second temperature abnormality information signal, and the selection signal, and one temperature information output terminal outputting a temperature information signal based on the temperature abnormality information signal.

### BRIEF DESCRIPTION OF THE DRAWINGS

FIG. 1 shows a schematic configuration of a liquid ejection apparatus.

FIG. 2 shows a functional configuration of the liquid ejection apparatus.

FIG. 3 shows a schematic configuration of an ejection unit.

FIG. 4 shows an example of a signal waveform of a drive signal COM.

FIG. 5 shows a configuration of a drive signal selection circuit.

FIG. 6 shows an example of details of decoding in a decoder.

FIG. 7 shows a configuration of a selection circuit.

FIG. 8 shows an operation of the drive signal selection circuit.

FIG. 9 shows an example of a configuration of a temperature abnormality detection circuit.

FIG. 10 shows an example of a configuration of an acquired information selection circuit.

FIG. 11 shows example of an information selection signal.

FIG. 12 shows an example of a determination method of the presence or absence of temperature abnormality in the drive signal selection circuit 200 provided in each of print heads 22-1 to 22-6.

FIG. 13 shows an example of a configuration of an acquired information selection circuit of a second embodiment.

FIG. 14 shows an example of a configuration of a temperature abnormality detection circuit of the second embodiment.

FIG. 15 shows an example of a configuration of an acquired information selection circuit of a third embodiment.

FIG. 16 shows an example of a configuration of an acquired information selection circuit of a fourth embodiment.

FIG. 17 shows a relationship between temperature abnormality information signal CS output from a temperature information output circuit of the fourth embodiment and an information selection signal SEL.

### DESCRIPTION OF EMBODIMENTS

As below, preferred embodiments of the present disclosure will be described using the drawings. The drawings to be used are for convenience of explanation. Note that the embodiments to be described do not unduly limit the present disclosure described in Claims. Further, not all of the configurations to be described are essential component elements of the present disclosure.

### 1. First Embodiment

### 1.1 Structure of Liquid Ejection Apparatus

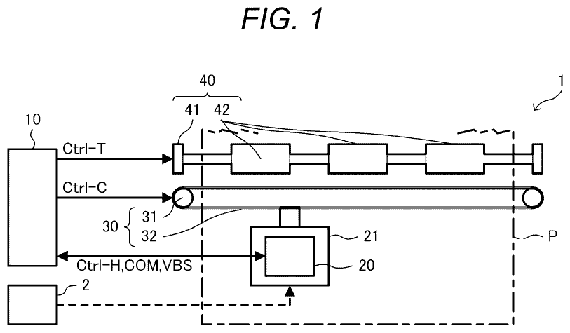

FIG. 1 shows a schematic configuration of a liquid ejection apparatus 1. The liquid ejection apparatus 1 of the first embodiment is a serial printing-type inkjet printer in which a carriage 21 with a head unit 20 for ejecting an ink as an example of a liquid reciprocates along a scanning axis and the ink is ejected to a medium P conveyed along a conveyance direction, and thereby, a desired image is formed on the medium P. Note that the liquid ejection apparatus 1 is not limited to the serial printing-type inkjet printer, but may be a line printing-type inkjet printer. As the medium P used in the liquid ejection apparatus 1, any printing object including printing paper, a resin film, and a fabric can be used.

As shown in FIG. 1, the liquid ejection apparatus 1 includes an ink container 2, a control unit 10, the head unit 20, a movement unit 30, and a conveyance unit 40.

The ink container 2 stores a plurality of types of inks to be ejected onto the medium P. The colors of the inks stored in the ink container 2 include black, cyan, magenta, yellow, red, and gray. As the ink container 2 storing the inks, an ink cartridge, a bag-shaped ink pack formed using a flexible film, an ink tank in which the inks can be replenished, or the like may be used.

The control unit 10 includes, for example, a processing circuit such as a center processing unit (CPU) or a field programmable gate array (FPGA) and a memory circuit such as a semiconductor memory, and controls the respective elements of the liquid ejection apparatus 1 including the head unit 20.

The head unit 20 is mounted on the carriage 21. The carriage 21 is fixed to an endless belt 32 provided in the movement unit 30. Note that, the ink container 2 may be mounted on the carriage 21 in addition to the head unit 20.

A control signal Ctrl-H for controlling the head unit 20 output by the control unit 10, a drive signal COM for driving the head unit 20, and a reference voltage signal VBS are input to the head unit 20 mounted on the carriage 21. Further, the ink stored in the ink container 2 is supplied to the head unit 20 via a tube (not shown). The head unit 20 ejects the ink supplied from the ink container 2 based on the input control signal Ctrl-H, drive signal COM, and reference voltage signal VBS.

The movement unit 30 includes a carriage motor 31 and the endless belt 32. The carriage motor 31 drives based on a control signal Ctrl-C input from the control unit 10. The endless belt 32 rotates according to the driving of the carriage motor 31. Thereby, the carriage 21 fixed to the endless belt 32 reciprocates along the scanning axis. That is, the head unit 20 mounted on the carriage 21 reciprocates along the scanning axis intersecting the conveyance direction in which the medium P is conveyed.

The conveyance unit 40 includes a conveyance motor 41 and conveyance rollers 42. The conveyance motor 41 drives based on the control signal Ctrl-T input from the control unit 10. The conveyance roller 42 rotates according to the driving of the conveyance motor 41. With the rotation of the conveyance rollers 42, the medium P is conveyed in the conveyance direction.

As described above, in the liquid ejection apparatus 1, the head unit 20 mounted on the carriage 21 ejects the ink to the medium P with the conveyance of the medium P by the conveyance unit 40 and the reciprocating movement of the carriage 21 by the movement unit 30. Thereby, the ink ejected from the head unit 20 lands on a certain position on the surface of the medium P. As a result, a desired image is formed on the medium P.

### 1.2 Functional Configuration of Liquid Ejection Apparatus

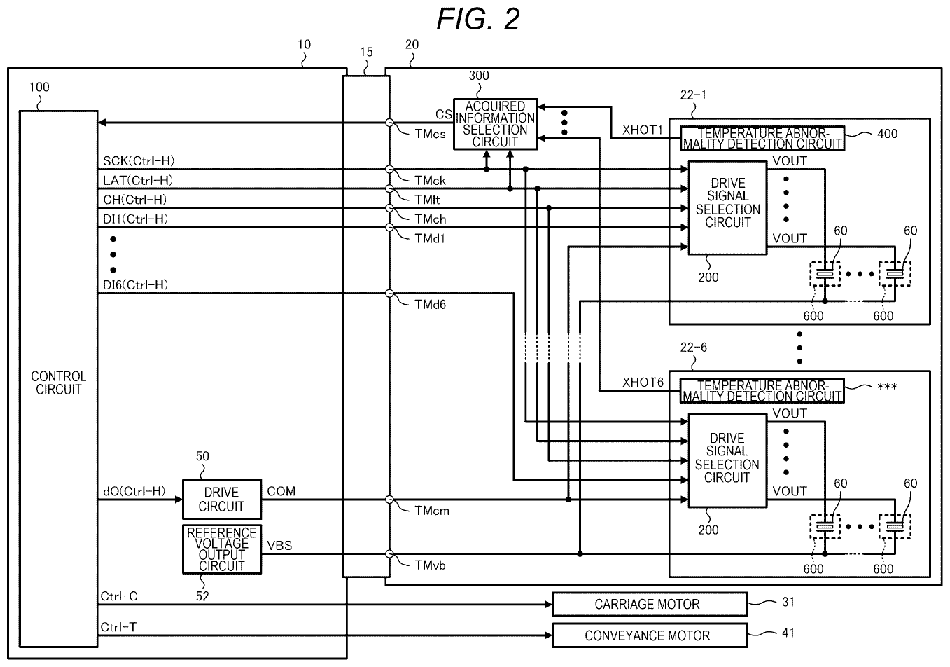

Next, a functional configuration of the liquid ejection apparatus 1 will be described. FIG. 2 shows the functional configuration of the liquid ejection apparatus 1. As shown in FIG. 2, the liquid ejection apparatus 1 includes the control unit 10, the head unit 20, the carriage motor 31, the conveyance motor 41, and a cable 15.

The cable 15 electrically couples the control unit 10 and the head unit 20. It is preferable that the cable 15 has flexibility that can follow the movement of the carriage 21. For example, a flexible flat cable (FFC) can be used.

The control unit 10 includes a drive circuit 50, a reference voltage output circuit 52, and a control circuit 100. The control circuit 100 includes, for example, a processing circuit such as a CPU or an FPGA and a memory circuit such as a semiconductor memory. An image information signal containing image data and the like is input to the control circuit 100 from an external apparatus such as a host computer communicably connected to the outside the liquid ejection apparatus 1. The control circuit 100 generates various signals for controlling the liquid ejection apparatus 1 based on the input image information signal, and outputs the signals to the corresponding configurations.

Specifically, the control circuit 100 recognizes the scanning position of the head unit 20 mounted on the carriage 21 based on a signal corresponding to the scanning position of the carriage 21 input from a linear encoder (not shown) or the like. The control circuit 100 generates various signals according to the recognized scanning position of the head unit 20 and the input image information signal and outputs the signals.

Specifically, the control circuit 100 generates the control signal Ctrl-C for controlling the movement of the head unit 20 along the scanning axis according to the scanning position of the head unit 20, and outputs the control signal to the carriage motor 31. Thereby, the carriage motor 31 drives to control the movement and the scanning position of the head unit 20 mounted on the carriage 21 along the scanning axis. Further, the control circuit 100 generates the control signal Ctrl-T for controlling the conveyance of the medium P, and outputs the control signal to the conveyance motor 41. Thereby, the conveyance motor 41 drives to control the movement of the medium P along the conveyance direction. Note that the control signal Ctrl-C may be converted through a driver circuit (not shown) and then input to the carriage motor 31, and the control signal Ctrl-T may be converted through a driver circuit (not shown) and then input to the conveyance motor 41.

The control circuit 100 generates drive data signals DI1 to DI6, a change signal CH, a latch signal LAT, and a clock signal SCK as the control signals Ctrl-H for controlling the head unit 20 based on the image information signal input from the external apparatus and the scanning position of the head unit 20 input from the linear encoder (not shown), and outputs the signals to the head unit 20.

The control circuit 100 outputs a base drive signal dO as a digital signal to the drive circuit 50 as the control signal Ctrl-H. The drive circuit 50 performs digital/analog signal conversion on the input base drive signal dO, then performs class D amplification on the converted analog signal, and generates the drive signal COM, and outputs the signal to the head unit 20. That is, the drive signal dO output by the control circuit 100 is the digital signal that defines the waveform of the drive signal COM. The base drive signal dO may be an analog signal as long as the signal can define the waveform of the drive signal COM output by the drive circuit 50.

The reference voltage output circuit 52 generates the reference voltage signal VBS and outputs the signal to the head unit 20. The reference voltage signal VBS output by the reference voltage output circuit 52 is a signal of a potential as a reference for driving of a piezoelectric element 60, which will be described later, and may be, for example, a constant signal at the ground potential or a constant direct-current voltage signal at a potential of 5.5 V, 6 V, or the like.

Here, the drive circuit 50 that outputs the drive signal COM and the reference voltage output circuit 52 that outputs the reference voltage signal VBS may be provided in the head unit 20.

The head unit 20 includes an acquired information selection circuit 300 and print heads 22-1 to 22-6. Each of the print heads 22-1 to 22-6 includes a temperature abnormality detection circuit 400, a drive signal selection circuit 200, and a plurality of ejection units 600, and each of the plurality of ejection unit 600 includes the piezoelectric element 60. Further, the head unit 20 includes terminals TMcs, TMck, TMlt, TMch, TMd1 to TMd6 to which the cable 15 is coupled. Furthermore, to the head unit 20, the clock signal SCK is input via the terminal TMck, the latch signal LAT is input via the terminal TMlt, the change signal CH is input via the terminal TMch, the drive data signals DI1 to DI6 are input via the terminals TMd1 to TMd6, the drive signal COM is input via a terminal TMcm, and the reference voltage signal VBS is input via a terminal TMvb. The head unit 20 outputs temperature abnormality information signal CS, which will be described later, via a terminal TMcs.

The drive data signal DI1, the change signal CH, the latch signal LAT, and the clock signal SCK output by the control circuit 100, the drive signal COM output by the drive circuit 50, and the reference voltage signal VBS output by the reference voltage output circuit 52 are input to the print head 22-1.

The clock signal SCK, the latch signal LAT, the change signal CH, the drive data signal DI1, and the drive signal COM input to the print head 22-1 are input to the drive signal selection circuit 200. The drive signal selection circuit 200 selects or deselects the signal waveform of the drive signal COM based on the input clock signal SCK, latch signal LAT, change signal CH, and drive data signal DI1, and thereby, generates a drive signal VOUT corresponding to each of the plurality of piezoelectric elements 60. Then, the drive signal selection circuit 200 individually outputs the generated drive signal VOUT to one end of the corresponding piezoelectric element 60. Further, the reference voltage signal VBS is commonly supplied to the other ends of the plurality of piezoelectric elements 60. Each of the plurality of piezoelectric elements 60 is driven by a potential difference between the drive signal VOUT individually supplied to one end and the reference voltage signal VBS commonly supplied to the other end. An amount of the ink according to the driving of the piezoelectric element 60 is ejected from the print head 22-1.

The temperature abnormality detection circuit 400 is located near the drive signal selection circuit 200, and detects whether temperature abnormality occurs in the drive signal selection circuit 200. Then, the temperature abnormality detection circuit 400 generates a temperature state signal XHOT1 corresponding to the temperature of the drive signal selection circuit 200 and outputs the signal from the print head 22-1.

Here, the print heads 22-2 to 22-6 have the same configuration as the print head 22-1 except for the input signals and the output signals, and execute the same operation. Specifically, the clock signal SCK, the latch signal LAT, the change signal CH, the drive data signal DIi, the drive signal COM, and the reference voltage signal VBS are input to the print head 22-i (i is one of 1 to 6). The, the drive signal selection circuit 200 of the print head 22-i selects or deselects the signal waveform of the drive signal COM based on the input clock signal SCK, latch signal LAT, change signal CH, and drive data signal DIi, and thereby, generates the drive signal VOUT corresponding to each of the plurality of piezoelectric elements 60.

The drive signal VOUT generated by the drive signal selection circuit 200 is individually supplied to one end of the corresponding piezoelectric element 60. Further, the reference voltage signal VBS is commonly supplied to the other ends of the plurality of piezoelectric elements 60 of the print head 22-i. Thereby, the plurality of piezoelectric elements 60 of the print head 22-i are respectively driven, and amounts of inks according to the driving of the piezoelectric elements 60 are ejected from the print head 22-i.

The temperature abnormality detection circuit 400 of the print head 22-i is located near the drive signal selection circuit 200 of the print head 22-i, and detects whether temperature abnormality occurs in the drive signal selection circuit 200. The temperature abnormality detection circuit 400 generates a temperature state signal XHOTi corresponding to the temperature of the drive signal selection circuit 200 and outputs the signal from the print head 22-i.

In the following description, when it is not necessary to distinguish among the print heads 22-1 to 22-6, the print heads may simply be referred to as a print head 22. Here, the clock signal SCK, the latch signal LAT, the change signal CH, the drive data signal DI, the drive signal COM, and the reference voltage signal VBS are input to the print head 22, and the print head outputs the temperature state signal XHOT.

The temperature state signals XHOT1 to XHOT6 output by the print heads 22-1 to 22-6, the drive data signal DI1, and the clock signal SCK are input to the acquired information selection circuit 300.

The acquired information selection circuit 300 acquires the drive data signal DI1 based on the clock signal SCK, and analyzes a command contained in the acquired drive data signal DI1. Then, the acquired information selection circuit 300 generates the temperature abnormality information signal CS according to the analysis result of the drive data signal DI1 and the temperature state signals XHOT1 to XHOT6, and outputs the temperature abnormality information signal from the head unit 20 via the terminal TMcs.

As described above, the drive data signal DI1 is input to the drive signal selection circuit 200 of the print head 22-1 and also input to the acquired information selection circuit 300. The drive data signal DI1 contains information for controlling the ejection of the ink from the above-described print head 22-1 and information for controlling the operation of the acquired information selection circuit 300. That is, the control circuit 100 outputs the drive data signal DI1 containing the information for controlling the ejection of ink from the print head 22-1 and the drive data signal DI1 containing the information for controlling the operation of the acquired information selection circuit 300. The acquired information selection circuit 300 determines whether the drive data signal DI1 is the signal for controlling the ejection of ink from the print head 22-1 or the signal for controlling the operation of the acquired information selection circuit 300 according to whether a specific code is contained in the input drive data signal DI1. When determining that the input drive data signal DI1 is the signal for controlling the operation of the acquired information selection circuit 300, the acquired information selection circuit 300 executes processing according to the drive data signal DI1. Accordingly, it is not necessary to provide a dedicated signal line for transmitting a command for controlling the operation of the acquired information selection circuit 300 in the cable 15 that electrically couples the control unit 10 and the head unit 20, and the number of signal lines contained in the cable 15 can be reduced.

The acquired information selection circuit 300 may determine whether the drive data signal DI1 is the signal for controlling the ejection of ink from the print head 22-1 or the signal for controlling the operation of the acquired information selection circuit 300 based on the timing at which the drive data signal DI1 is input.

The temperature abnormality information signal CS output by the acquired information selection circuit 300 is input to the control circuit 100 via the terminal TMcs. The control circuit 100 recognizes the presence or absence of temperature abnormality in the head unit 20 based on the input temperature abnormality information signal CS. The head unit 20 corrects or stops output of various signals according to the presence or absence of temperature abnormality in the head unit 20. This improves the reliability of the liquid ejection apparatus 1.

### 1.3 Configuration of Ejection Unit

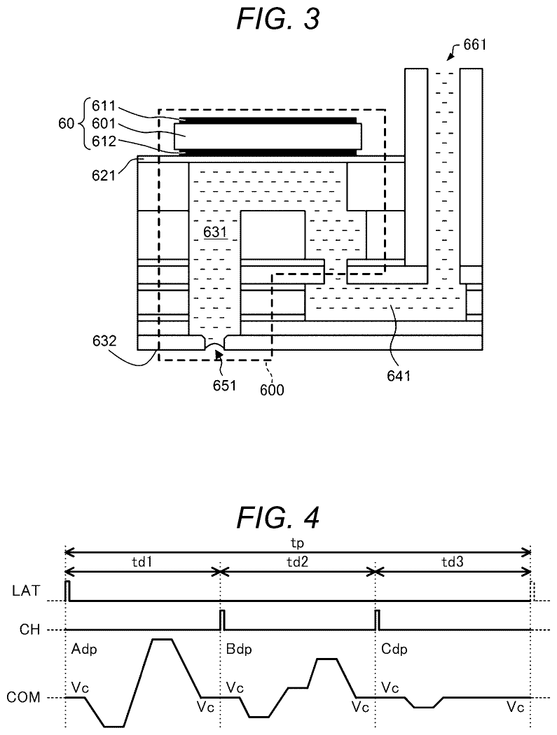

Next, the configuration of the ejection unit 600 of the print head 22 will be described. FIG. 3 shows a schematic configuration of one ejection unit 600 of the plurality of ejection units 600 of the print head 22. As shown in FIG. 3, the ejection unit 600 includes the piezoelectric element 60, a vibrating plate 621, a cavity 631, and a nozzle 651.

The cavity 631 is filled with the ink supplied from a reservoir 641. The reservoir 641 is provided in common to the plurality of ejection units 600 of the print head 22. Further, to the reservoir 641, the ink is introduced from the ink container 2 via an ink channel (not shown) and an ink supply port 661. That is, the cavity 631 is filled with the ink stored in the ink container 2.

The vibrating plate 621 is displaced by driving of the piezoelectric element 60 provided on the upper surface in FIG. 3. Then, with the displacement of the vibrating plate 621, the internal volume of the cavity 631 filled with the ink is increased and decreased. That is, the vibrating plate 621 functions as a diaphragm that changes the internal volume of the cavity 631.

The nozzle 651 is an opening portion provided in a nozzle plate 632 and communicates with the cavity 631. Further, with a change of the internal volume of the cavity 631, the amount of the ink according to the change of the internal volume is ejected from the nozzle 651.

The piezoelectric element 60 has a structure in which a piezoelectric body 601 is sandwiched between a pair of electrodes 611, 612. In the piezoelectric body 601 of the structure, center portions of the electrodes 611, 612 bend in the vertical directions together with the vibrating plate 621 in response to the potential difference between the voltages supplied by the electrodes 611, 612. Specifically, the drive signal VOUT is supplied to one of the electrodes 611, 612 of the piezoelectric element 60. Further, the reference voltage signal VBS as the reference for the displacement of the piezoelectric element 60 is supplied to the other of the electrodes 611, 612 of the piezoelectric element 60. For example, when the voltage level of the drive signal VOUT becomes higher, the center portion of the piezoelectric element 60 bends upward, and when the voltage level of the drive signal VOUT becomes lower, the center portion bends downward.

In the ejection unit 600 having the above-described configuration, the piezoelectric element 60 is driven to bend upward, and thereby, the center portion of the vibrating plate 621 is displaced upward and the internal volume of the cavity 631 is increased. As a result, the ink is drawn in from the reservoir 641. On the other hand, the piezoelectric element 60 is driven to bend downward, and thereby, the center portion of the vibrating plate 621 is displaced downward and the internal volume of the cavity 631 is decreased. As a result, an amount of the ink according to the degree of decrease is ejected from the nozzle 651. That is, the head unit 20 has the plurality of ejection units 600 including the piezoelectric elements 60 and ejecting the ink by driving of the piezoelectric elements 60.

Note that the structure of the piezoelectric element 60 provided in the ejection unit 600 is not limited to the structure shown in FIG. 3, but may be any structure as long as the ink can be ejected from the ejection unit 600. Accordingly, the configuration of the piezoelectric element 60 is not limited to the above-described flexural vibration configuration, but may be a longitudinal vibration configuration. Further, the piezoelectric element 60 may have a configuration in which the center portion bends upward when the voltage level of the drive signal VOUT becomes lower, and the center portion bends downward when the voltage level of the drive signal VOUT becomes higher.

### 1.4 Functional Configuration of Drive Signal Selection Circuit

Next, the configuration and the operation of the drive signal selection circuit 200 of the print head 22 will be described. As described above, the drive signal selection circuit 200 of the print head 22 selects or deselects the signal waveform contained in the drive signal COM based on the clock signal SCK, the drive data signal DI, the latch signal LAT, and the change signal CH, and thereby, generates the drive signal VOUT and outputs the signal to the piezoelectric element 60 provided in the corresponding ejection unit 600. The drive signal selection circuit 200 is configured, for example, as an integrated circuit device.

For explanation of the configuration and the operation of the drive signal selection circuit 200, first, an example of the waveform of the drive signal COM input to the drive signal selection circuit 200 will be described. FIG. 4 shows the example of the signal waveform of the drive signal COM. As shown in FIG. 4, the drive signal COM includes a trapezoidal waveform Adp disposed in a period td1 from when the latch signal LAT rises to when the change signal CH rises, a trapezoidal waveform Bdp disposed in a period td2 from when the change signal CH rises to when the change signal CH rises next, and a trapezoidal waveform Cdp disposed in a period td3 from when the change signal CH rises to when the latch signal LAT rises.

The trapezoidal waveform Adp signal waveform for driving the piezoelectric element 60 so that a predetermined amount of the ink is ejected, and the trapezoidal waveform Bdp is a signal waveform for driving the piezoelectric element 60 so that a smaller amount of the ink than the predetermined amount is ejected. The trapezoidal waveform Cdp is a signal waveform for driving the piezoelectric element 60 to such a degree that the ink is not ejected, and is a signal waveform for vibrating the ink in the vicinity of the nozzle opening portion corresponding to the piezoelectric element 60 to reduce the likelihood of an increase in ink viscosity near the nozzle opening portion. The trapezoidal waveforms Adp, Bdp, and Cdp are the signal waveforms having a common voltage value of a voltage Vc at the respective start timing and end timing. That is, each of the trapezoidal waveforms Adp, Bdp, and Cdp starts at the voltage Vc and ends at the voltage Vc.

In the following description, when the trapezoidal waveform Adp is supplied to the piezoelectric element 60, the predetermined amount of the ink to be ejected may be referred to as a medium amount, and when the trapezoidal waveform Bdp is supplied to the piezoelectric element 60, the smaller amount of the ink than the predetermined amount to be ejected may be referred to as a small amount. Further, when the trapezoidal waveform Cdp is supplied to the piezoelectric element 60, a motion for preventing an increase in ink viscosity by vibrating the ink in the vicinity of the nozzle opening corresponding to the piezoelectric element 60 may be referred to as micro vibration. Note that the signal waveform of the drive signal COM shown in FIG. 4 is merely an example, and the present disclosure is not limited thereto. Various combinations of waveforms may be used according to the property of the ejected ink, the material of the medium P on which the ink is landed, and the like.

The drive signal selection circuit 200 selects or deselects the trapezoidal waveforms Adp, Bdp, Cdp contained in the drive signal COM in each of the periods td1, td2, and td3 based on the clock signal SCK, the drive data signal DI, the latch signal LAT, and the change signal CH. Thereby, in a period tp, the signal waveform of the drive signal VOUT supplied to the ejection unit 600, that is, the dot size formed on the medium P in the period tp is controlled.

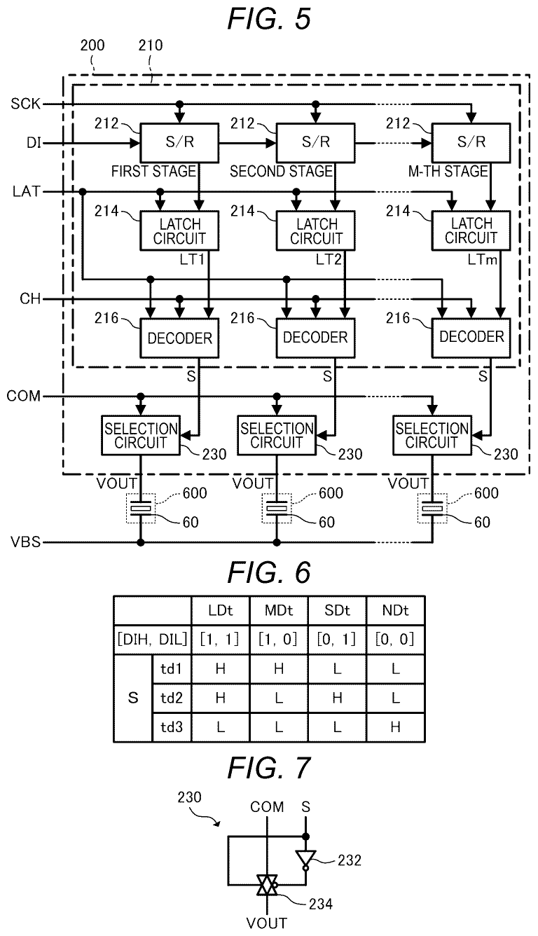

The configuration and the operation of the drive signal selection circuit 200 that generates the drive signal VOUT by selecting or deselecting the signal waveforms contained in the drive signal COM will be described. FIG. 5 shows the configuration of the drive signal selection circuit 200. As shown in FIG. 5, the drive signal selection circuit 200 includes a selection control circuit 210 and a plurality of selection circuits 230 in the same number as the plurality of ejection units 600. In the following description, the print head 22 has m ejection units 600.

To the selection control circuit 210, the clock signal SCK, the drive data signal DI, the latch signal LAT, and the change signal CH are input. In the selection control circuit 210, a set including a shift register (S/R) 212, a latch circuit 214, and a decoder 216 is provided corresponding to each of the m ejection units 600. That is, the drive signal selection circuit 200 includes the m shift registers 212, the m latch circuits 214, and the m decoders 216.

The drive data signal DI is input to the selection control circuit 210 in synchronization with the clock signal SCK. The drive data signal DI serially includes 2-bit drive data [DIH, DIL] for selection of one of a large dot LDt, a medium dot MDt, a small dot SDt, and a non-record NDt in correspondence with each of the m ejection units 600. The drive data [DIH, DIL] contained in the drive data signal DI is held in the m shift registers 212 corresponding to the m ejection units 600. Specifically, the m shift registers 212 corresponding to the piezoelectric elements 60 are cascade-coupled to one another, and the serially input drive data signal DI is sequentially transferred to the shift registers 212 at the downstream stages according to the clock signal SCK. The drive data [DIH, DIL] is held in the corresponding shift register 212, and thereby, the clock signal SCK is stopped. As a result, the drive data [DIH, DIL] contained in the drive data signal DI is held in the corresponding shift register 212. In FIG. 5, to distinguish among the m shift registers 212, the shift registers are denoted by first stage, second stage, . . . , and mth stage in order from an upstream side to which the drive data signal DI is input.

The respective m latch circuits 214 latch the drive data [DIH, DIL] held in the corresponding shift registers 212 at the same time at the rise of the latch signal LAT. The drive data [DIH, DIL] latched by the latch circuit 214 is input to the corresponding decoder 216. FIG. 6 shows an example of details of decoding in the decoder 216. The decoder 216 outputs a waveform selection signal S of the logic level defined by the input drive data [DIH, DIL] in each of the periods td1, td2, and td3. For example, when the driving data [DIH, DIL]=[1, 0] is input to the decoder 216, the decoder 216 outputs the waveform selection signal S at the logic level as H, L, and L levels in the periods td1, td2, and td3.

The waveform selection signal S output by the decoder 216 is input to the selection circuit 230. The selection circuit 230 is provided in correspondence with each of the m ejection units 600. That is, the drive signal selection circuit 200 includes the m selection circuits 230 in the same number as the m ejection units 600. FIG. 7 shows a configuration of the selection circuit 230. As shown in FIG. 7, the selection circuit 230 includes an inverter 232 as a NOT circuit and a transfer gate 234.

The waveform selection signal S is input to a positive control terminal without a circle in the transfer gate 234, and is also input to a negative control terminal with a circle in the transfer gate 234 after the logic level is inverted by the inverter 232. The drive signal COM is supplied to an input terminal of the transfer gate 234. The transfer gate 234 sets continuity between the input terminal and an output terminal when the waveform selection signal S at the high level is input, and sets discontinuity between the input terminal and the output terminal when the waveform selection signal S at the low level is input. That is, the transfer gate 234 outputs the signal waveform contained in the drive signal COM from the output terminal when the logic level of the wavelength selection signal S is the high level, and does not output the signal waveform contained in the drive signal COM from the output terminal when the logic level of the waveform selection signal S is the low level. Then, the drive signal selection circuit 200 outputs a signal output to the output terminal of the transfer gate 234 provided in the selection circuit 230 as the drive signal VOUT.

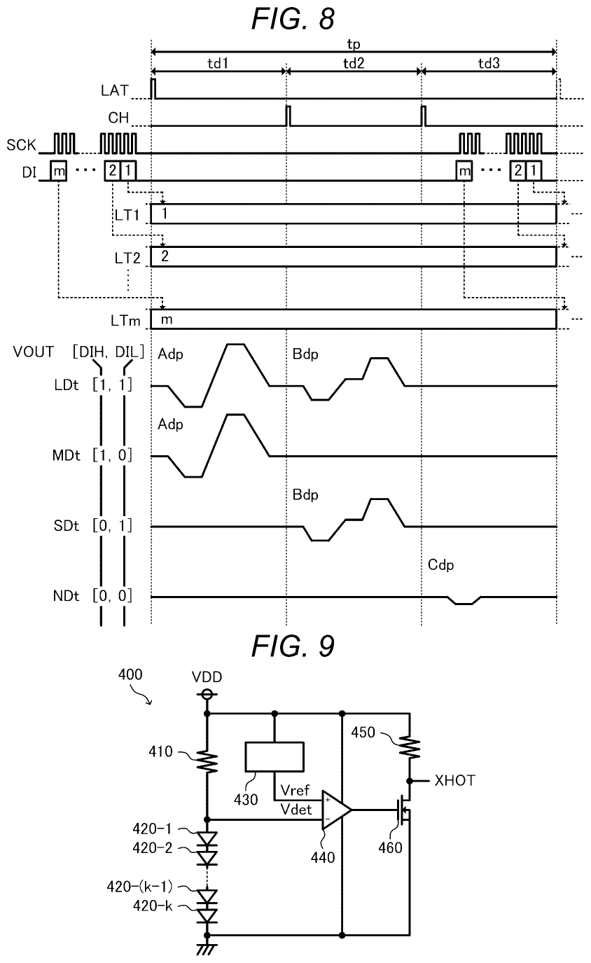

Here, the operation of the drive signal selection circuit 200 is described. FIG. 8 shows the operation of the drive signal selection circuit 200. The drive data signal DI is input to the selection control circuit 210 as a serial signal synchronized with the clock signal SCK. Then, the drive data signal DI is sequentially transferred in the m shift registers 212 corresponding to the m ejection units 600 in synchronization with the clock signal SCK. Then, when the input of the clock signal SCK is stopped, the drive data [DIH, DIL] corresponding to each of the m ejection units 600 is held in the shift register 212. The drive data signals DI are input in the order corresponding to the ejection units 600 of the mth-stage, . . . , second-stage, first-stage shift registers 212.

When the latch signal LAT rises, the respective latch circuits 214 latch the drive data [DIH, DIL] held in the shift register 212 at the same time. Note that LT1, LT2, . . . , LTm shown in FIG. 8 show drive data [DIH, DIL] latched by the latch circuits 214 corresponding to the first-stage, second-stage, mth-stage shift registers 212.

The decoder 216 outputs the logic level of the waveform selection signal S with the settings shown in FIG. 6 in each of the periods td1, td2, and td3 according to the size of the dot defined by the latched drive data [DIH, DIL]. Then, the selection circuit 230 selects or deselects the signal waveform contained in the drive signal COM according to the logic level of the waveform selection signal S output by the decoder 216 to generate the drive signal VOUT.

Specifically, when the drive data [DIH, DIL]=[1, 1] is input to the decoder 216, the decoder 216 sets the logic level of the waveform selection signal S to H, H, and L levels in the periods td1, td2, and td3. Thereby, the selection circuit 230 selects the trapezoidal waveform Adp in the period td1, selects the trapezoidal waveform Bdp in the period td2, and deselects the trapezoidal waveform Cdp in the period td3. As a result, the drive signal selection circuit 200 outputs the drive signal VOUT corresponding to the large dot LDt.

When the drive signal VOUT corresponding to the large dot LDt is supplied to the piezoelectric element 60 provided in the corresponding ejection unit 600, the medium amount of the ink is ejected in the period td1, the small amount of the ink is ejected in the period td2, and the ink is not ejected in the period td3. Then, the medium amount of the ejected ink and the small amount of the ejected ink land on the medium P and combine, and thereby, the large dot LDt is formed on the medium P.

When the drive data [DIH, DIL]=[1, 0] is input to the decoder 216, the decoder 216 sets the logic level of the waveform selection signal S to H, L, and L levels in the periods td1, td2, and td3. Thereby, the selection circuit 230 selects the trapezoidal waveform Adp in the period td1, deselects the trapezoidal waveform Bdp in the period td2, and deselects the trapezoidal waveform Cdp in the period td3. As a result, the drive signal selection circuit 200 outputs the drive signal VOUT corresponding to the medium dot MDt.

When the drive signal VOUT corresponding to the medium dot MDt is supplied to the piezoelectric element 60 provided in the corresponding ejection unit 600, the medium amount of the ink is ejected in the period td1, the ink is not ejected in the period td2, and the ink is not ejected in the period td3. Then, the medium amount of the ejected ink lands on the medium P, and the medium dot MDt is formed on the medium P.

When the drive data [DIH, DIL]=[0, 1] is input to the decoder 216, the decoder 216 sets the logic level of the waveform selection signal S to L, H, and L levels in the periods td1, td2, and td3. Thereby, the selection circuit 230 deselects the trapezoidal waveform Adp in the period td1, selects the trapezoidal waveform Bdp in the period td2, and deselects the trapezoidal waveform Cdp in the period td3. As a result, the drive signal selection circuit 200 outputs the drive signal VOUT corresponding to the small dot SDt.

When the drive signal VOUT corresponding to the small dot SDt is supplied to the piezoelectric element 60 provided in the corresponding ejection unit 600, the ink is not ejected in the period td1, the small amount of the ink is ejected in the period td2, and the ink is not ejected in the period td3. Then, the small amount of the ejected ink lands on the medium P, and the small dot SDt is formed on the medium P.

When the drive data [DIH, DIL]=[0, 0] is input to the decoder 216, the decoder 216 sets the logic level of the waveform selection signal S to L, L, and H levels in the periods td1, td2, and td3. Thereby, the selection circuit 230 deselects the trapezoidal waveform Adp in the period td1, deselects the trapezoidal waveform Bdp in the period td2, and selects the trapezoidal waveform Cdp in the period td3. As a result, the drive signal selection circuit 200 outputs the drive signal VOUT corresponding to the non-record NDt.

When the drive signal VOUT corresponding to the non-record NDt is supplied to the piezoelectric element 60 provided in the corresponding ejection unit 600, the ink is not ejected in the period td1, the ink is not ejected in the period td2, and the ink is not ejected in the period td3. Accordingly, the ink is not ejected from the ejection unit 600, and the non-record NDt without a dot formed on the medium P is obtained. At the same time, the drive signal VOUT containing the trapezoidal waveform Cdp is input to the corresponding piezoelectric element 60. Therefore, the micro vibration is performed. As a result, the likelihood of an increase in ink viscosity near the nozzle opening portion of the corresponding ejection unit 600 is reduced.

As described above, in the liquid ejection apparatus 1 of the first embodiment, the print head 22 has the piezoelectric element 60 which is driven by the supply of the drive signal COM, and ejects the ink as an example of the liquid by driving the piezoelectric element 60. That is, the head unit 20 includes the plurality of drive signal selection circuits 200 respectively corresponding to the print heads 22-1 to 22-6, and the plurality of drive signal selection circuits 200 control driving of the piezoelectric elements 60 provided in the ejection units 600 of the corresponding print heads 22.

### 1.5 Configuration of Temperature Abnormality Detection Circuit

Next, a specific example of the configuration and the operation of the temperature abnormality detection circuit 400 will be described. FIG. 9 shows an example of the configuration of the temperature abnormality detection circuit 400. As shown in FIG. 9, the temperature abnormality detection circuit 400 includes diodes 420-1 to D420-k, a reference voltage generation circuit 430, a comparator 440, a transistor 460, and resistors 410 and 450. For example, the temperature abnormality detection circuit 400 is configured as an integrated circuit device, and is disposed near the above-described drive signal selection circuit 200. Here, the integrated circuit device forming the temperature abnormality detection circuit 400 and the integrated circuit device forming the drive signal selection circuit 200 may be the same integrated circuit device. In other words, the temperature abnormality detection circuit 400 and the drive signal selection circuit 200 may be mounted on a single integrated circuit device.

A voltage signal VDD having a constant voltage value is supplied to the temperature abnormality detection circuit 400. The voltage signal VDD supplied to the temperature abnormality detection circuit 400 may be generated based on the bandgap reference of the integrated circuit device including the temperature abnormality detection circuit 400, or may be generated by a power supply circuit (not shown) provided outside the temperature abnormality detection circuit 400.

The voltage signal VDD supplied to the temperature abnormality detection circuit 400 is input to one end of the reference voltage generation circuit 430, one end of the resistor 410, and one end of the resistor 450. The reference voltage generation circuit 430 transforms the voltage value of the input voltage signal VDD to generate a voltage signal Vref having a constant voltage value. Then, the voltage signal Vref generated by the reference voltage generation circuit 430 is input to the positive-side input terminal of the comparator 440. The other end of the resistor 410 is electrically coupled to the anode terminal of the diode 420-1. The cathode terminal of the diode 420-1 is electrically coupled to the anode terminal of the diode 420-2, the cathode terminal of the diode 420-2 is electrically coupled to the anode terminal of the diode 420-3, and the cathode terminal of the diode 420-j (j is one of 1 to k−1) is electrically coupled to the anode terminal of the diode 420-(j+1). That is, the diodes 420-1 to 420-k are coupled in series to each other. Here, the anode terminal of the diode 420-1 provided in one end portion of the series-coupled diodes 420-1 to 420-k is electrically coupled to the other end of the resistor 410, and the ground potential is supplied to the cathode terminal of the diode 420-k provided in the other end portion of the series-coupled diodes 420-1 to 420-k.

Further, a signal at a coupling point where the other end of the resistor 410 and the anode terminal of the diode 420-1 are electrically coupled having a voltage value as the sum of the forward voltages of the series-coupled diodes 420-1 to 420-k is input to the negative-side input terminal of the comparator 440 as a voltage signal Vdet.

The comparator 440 operates using a potential difference between the voltage signal VDD supplied to a high-potential side power supply terminal and a signal of the ground potential supplied to a low-potential side power supply terminal as a drive source. The output terminal of the comparator 440 is electrically coupled to the gate terminal of the transistor 460. The drain terminal of the transistor 460 is electrically coupled to the other end of the resistor 450, and the ground potential is supplied to the source terminal of the transistor 460. Further, a signal of the drain terminal of the transistor 460 is output from the temperature abnormality detection circuit 400 as the temperature state signal XHOT.

In the temperature abnormality detection circuit 400 having the above-described configuration, the voltage values of the forward voltages of the respective diodes 420-1 to 420-k become lower when the temperature of the diodes 420-1 to 420-k is higher. That is, the voltage value of the voltage signal Vdet varies depending on the temperature of the diodes 420-1 to 420-k as the temperature of the drive signal selection circuit 200 located near the diodes 420-1 to 420-k. The voltage signal Vdet having the voltage value thus varying depending on the temperature is input to the negative-side input terminal of the comparator 440.

The comparator 440 compares the voltage value of the voltage signal Vref input to the positive-side input terminal with the voltage value of the voltage signal Vdet input to the negative-side input terminal. Further, the comparator 440 outputs a signal at the L level having the voltage value as the ground potential when the voltage value of the voltage signal Vdet is higher than the voltage value of the voltage signal Vref, and outputs a signal at the H level having the voltage value as the voltage signal VDD when the voltage value of the voltage signal Vdet is lower than the voltage value of the voltage signal Vref.

Here, for example, the voltage value of the voltage signal Vref output by the reference voltage generation circuit 430 is set to the voltage value of the voltage signal Vdet input to the comparator 440 when the temperature of the drive signal selection circuit 200 is the highest temperature in the temperature range in which the drive signal selection circuit 200 can stably operate. That is, the comparator 440 outputs a signal at the L level when the temperature of the drive signal selection circuit 200 is within the temperature range in which the drive signal selection circuit 200 can stably operate, and at the H level when the temperature of the drive signal selection circuit 200 exceeds the temperature range in which the drive signal selection circuit 200 can stably operate. The voltage value of the voltage signal Vref input to the comparator 440 is specified not only based on the temperature of the drive signal selection circuit 200, but may be specified in consideration of the temperatures of the other configurations of the print head 22 in total.

The signal output by the comparator 440 is input to the gate terminal of the transistor 460. When a signal at the H level is input to the gate terminal, the transistor 460 sets continuity between the drain terminal and the source terminal. Concurrently, the temperature abnormality detection circuit 400 outputs the L-level temperature state signal XHOT. On the other hand, when a signal at the L level is input to the gate terminal, the transistor 460 sets discontinuity between the drain terminal and the source terminal. Concurrently, the temperature abnormality detection circuit 400 outputs the H-level temperature state signal XHOT.

That is, the temperature abnormality detection circuit 400 outputs the L-level temperature state signal XHOT when the temperature of the drive signal selection circuit 200 is out of the temperature range in which the drive signal selection circuit 200 can stably operate, and outputs the H-level temperature state signal XHOT when the temperature of the drive signal selection circuit 200 is within the temperature range in which the drive signal selection circuit 200 can stably operate. In other words, the temperature abnormality detection circuit 400 outputs the L-level temperature state signal XHOT when the temperature of the corresponding drive signal selection circuit 200 is abnormal, and outputs the H-level temperature state signal XHOT when the temperature of the corresponding drive signal selection circuit 200 is normal.

As described above, the head unit 20 includes the plurality of temperature abnormality detection circuits 400, and each of the plurality of temperature abnormality detection circuits 400 detects the presence or absence of temperature abnormality of the corresponding drive signal selection circuit 200.

### 1.6 Configuration of Acquired Information Selection Circuit

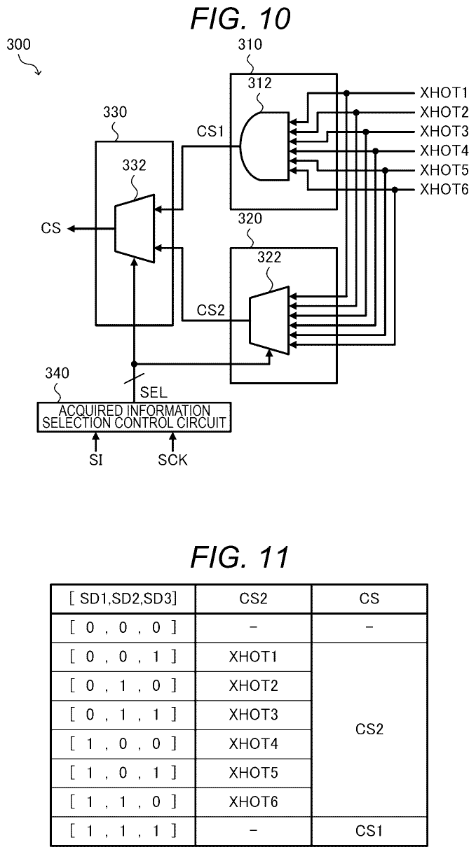

Next, the configuration and the operation of the acquired information selection circuit 300 will be described. FIG. 10 shows an example of the configuration of the acquired information selection circuit 300. As shown in FIG. 10, the acquired information selection circuit 300 includes an integrated information output circuit 310, an individual information output circuit 320, a temperature information output circuit 330, and an acquired information selection control circuit 340.

The clock signal SCK and the drive data signal DI1 are input to the acquired information selection control circuit 340. The acquired information selection control circuit 340 acquires the drive data signal DI1 at timing based on the clock signal SCK, and analyzes a command contained in the acquired drive data signal DI1. Then, the acquired information selection control circuit 340 generates and outputs an information selection signal SEL according to an analysis result.

The integrated information output circuit 310 outputs a detection result of the presence or absence of temperature abnormality of the plurality of drive signal selection circuits 200 respectively detected by the plurality of temperature abnormality detection circuits 400 of the head unit 20 as temperature abnormality information signal CS1 according to the temperature state signals XHOT1 to XHOT6.

Specifically, the integrated information output circuit 310 includes an AND circuit 312. The temperature state signals XHOT1 to XHOT6 output by the respective print heads 22-1 to 22-6 are input to the AND circuit 312. Then, the AND circuit 312 outputs a signal according to the logic levels of the input temperature state signals XHOT1 to XHOT6. The signal output by the AND circuit 312 is output from the integrated information output circuit 310 as the temperature abnormality information signal CS1.

As described above, in the liquid ejection apparatus 1 of the first embodiment, the temperature state signals XHOT1 to XHOT6 output by the respective print heads 22-1 to 22-6 are at the H level when the temperatures of the corresponding drive signal selection circuits 200 are normal, and at the L level when the temperatures of the corresponding drive signal selection circuits 200 are abnormal. The temperature state signals XHOT1 to XHOT6 are input to the AND circuit 312, and thereby, the integrated information output circuit 310 outputs the temperature abnormality information signal CS1 at the H level when all of the temperatures of the drive signal selection circuits 200 provided in the respective print heads 22-1 to 22-6 are normal, and at the L level when abnormality occurs in the temperature of at least one of the drive signal selection circuits 200 provided in the respective print heads 22-1 to 22-6.

That is, in the liquid ejection apparatus 1 of the first embodiment, the temperature abnormality detection circuit 400 of the print head 22-i outputs the temperature state signal at the L level when detecting a temperature abnormality of the drive signal selection circuit 200 of the print head 22-i and at the H level when not detecting the temperature abnormality of the drive signal selection circuit 200 of the print head 22-i as a detection result of the presence or absence of temperature abnormality of the drive signal selection circuit 200 of the print head 22-i. Here, the integrated information output circuit 310 includes the AND circuit 312. Accordingly, when all of the temperature state signals XHOT1 to XHOT6 indicate normality, the integrated information output circuit 310 outputs the temperature abnormality information signal CS1 containing normality information at the H level and, when at least one of the temperature state signals XHOT1 to XHOT6 indicates abnormality, outputs the temperature abnormality information signal CS1 containing abnormality information at the L level.

In other words, the integrated information output circuit 310 integrates information as to whether the temperatures of the drive signal selection circuits 200 provided in the respective print heads 22-1 to 22-6 of the head unit 20 are normal, and outputs the temperature abnormality information signal CS1 at the logic level that changes according to whether all of the temperatures of the drive signal selection circuits 200 provided in the respective print heads 22-1 to 22-6 of the head unit 20 are normal. Note that the integrated information output circuit 310 may include a circuit equivalent to an AND circuit instead of the AND circuit 312.

In response to the information selection signal SEL, the individual information output circuit 320 outputs temperature abnormality signal CS2 information corresponding to a detection result of the presence or absence of temperature abnormality of the plurality of drive signal selection circuits 200 respectively detected by the plurality of temperature abnormality detection circuits 400 of the head unit 20 as a detection result obtained by selection of one of the temperature state signals XHOT1 to XHOT6.

Specifically, the individual information output circuit 320 includes a multiplexer 322. The temperature state signals XHOT1 to XHOT6 output by the respective print heads 22-1 to 22-6 and the information selection signal SEL output by the acquired information selection control circuit 340 are input to the multiplexer 322. The multiplexer 322 selects and outputs one of the input temperature state signals XHOT1 to XHOT6 in response to the input information selection signal SEL. The signal output by the multiplexer 322 is output from the individual information output circuit 320 as the temperature abnormality information signal CS2.

That is, the individual information output circuit 320 of the first embodiment includes the multiplexer 322 that selects one of the temperature state signals XHOT1 to XHOT6 in response to the information selection signal SEL. In the individual information output circuit 320, the multiplexer 322 includes a plurality of input terminals including an input terminal to which the temperature state signal XHOT1 is input, an input terminal to which the temperature state signal XHOT2 is input, an input terminal to which the temperature state signal XHOT3 is input, an input terminal to which the temperature state signal XHOT4 is input, an input terminal to which the temperature state signal XHOT5 is input, an input terminal to which the temperature state signal XHOT6 is input, and an output terminal that outputs the temperature abnormality information signal CS2, and, when the temperature state signal XHOTi is selected in response to the information selection signal SEL, the input terminal to which the temperature state signal XHOTi is input and the output terminal that outputs the temperature abnormality information signal CS2 are electrically coupled and the other input terminals than the input terminal to which the temperature state signal XHOTi is input and the output terminal that outputs the temperature abnormality information signal CS2 are electrically decoupled. Accordingly, the individual information output circuit 320 selects the temperature state signal XHOTi from the temperature state signals XHOT1 to XHOT6 in response to the information selection signal SEL, and outputs the temperature state signal XHOTi as the temperature abnormality information signal CS2.

The individual information output circuit 320 may include, instead of the multiplexer 322, a switch element that switches the electrical coupling between the terminal to which the temperature state signal XHOT1 is input and the output terminal that outputs the temperature abnormality information signal CS2, a switch element that switches the electrical coupling between the terminal to which the temperature state signal XHOT2 is input and the output terminal that outputs the temperature abnormality information signal CS2, a switch element that switches the electrical coupling between the terminal to which the temperature state signal XHOT3 is input and the output terminal that outputs the temperature abnormality information signal CS2, a switch element that switches the electrical coupling between the terminal to which the temperature state signal XHOT4 is input and the output terminal that outputs the temperature abnormality information signal CS2, a switch element that switches the electrical coupling between the terminal to which the temperature state signal XHOT5 is input and the output terminal that outputs the temperature abnormality information signal CS2, and a switch element that switches the electrical coupling between the terminal to which the temperature state signal XHOT6 is input and the output terminal that outputs the temperature abnormality information signal CS2.

Even in the configuration, the continuity states of the respective switch elements are controlled by a signal obtained by decoding of the information selection signal SEL or the information selection signal SEL based on a predetermined condition, and thereby, the temperature state signal XHOTi can be selected from the temperature state signals XHOT1 to XHOT6 and output as the temperature abnormality information signal CS2. Note that, as the switch element in the configuration, for example, a field effect transistor (FET), a transmission gate, or the like can be used.

As described above, the individual information output circuit 320 selects one of the temperature state signals XHOT1 to XHOT6 output by the respective print heads 22-1 to 22-6 in response to the information selection signal SEL output from the acquired information selection control circuit 340, and outputs the temperature state signal XHOTi output by the selected print head 22-i as the temperature abnormality information signal CS2.

That is, the individual information output circuit 320 selects the temperature state signal XHOTi from the temperature state signals XHOT1 to XHOT6 in response to the information selection signal SEL, outputs the H-level temperature abnormality information signal CS2 containing normality information regardless of the logic level of the temperature state signal XHOT not selected from the temperature state signals XHOT1 to XHOT6 in response to the information selection signal SEL when the selected temperature state signal XHOTi indicates that the temperature of the corresponding drive signal selection circuit 200 is normal and the logic level of the temperature state signal XHOTi is the H level, and selects the temperature state signal XHOTi from the temperature state signals XHOT1 to XHOT6 in response to the information selection signal SEL and outputs the L-level temperature abnormality information signal CS2 containing the abnormality information regardless of the logic level of the temperature state signal XHOT not selected from the temperature state signals XHOT1 to XHOT6 in response to the information selection signal SEL when the selected temperature state signal XHOTi indicates that the temperature of the corresponding drive signal selection circuit abnormal and the logic level of the temperature state signal XHOTi is the L level.

In other words, the individual information output circuit 320 individually acquires and outputs information as to whether the temperatures of the respective drive signal selection circuits 200 provided in the respective print heads 22-1 to 22-6 of the head unit 20 are normal in response to the information selection signal SEL as the temperature abnormality information signal CS2.

The temperature information output circuit 330 outputs temperature abnormality information signal CS corresponding to the temperature abnormality information signal CS1, the temperature abnormality information signal CS2, and the information selection signal SEL.

Specifically, the temperature information output includes the multiplexer 332. The temperature abnormality information signal CS1 output by the integrated information output circuit 310, the temperature abnormality information signal CS2 output by the individual information output circuit 320, and the information selection signal SEL output by the acquired information selection control circuit 340 are input to the multiplexer 332. The multiplexer 332 selects and outputs the temperature abnormality information signal CS1 or the temperature abnormality information signal CS2 in response to the input information selection signal SEL. The signal output by the multiplexer 332 is output from the temperature information output circuit 330 as the temperature abnormality information signal CS.

That is, the temperature information output circuit 330 switches between outputting the temperature abnormality information signal CS1 according to whether all of the temperatures of the drive signal selection circuits 200 provided in the respective print heads 22-1 to 22-6 of the head unit 20 are normal as the temperature abnormality information signal CS and outputting the temperature abnormality information signal CS2 according to whether the respective drive signal selection circuits 200 provided in the respective print heads 22-1 to 22-6 of the head unit 20 are normal as the temperature abnormality information signal CS in response to the information selection signal SEL.

The temperature abnormality information signal CS output by the temperature information output circuit 330 is output from the acquired information selection circuit 300. That is, the temperature information output circuit 330 selects and outputs the temperature abnormality information signal CS1 or the temperature abnormality information signal CS2 in response to the information selection signal SEL as the temperature abnormality information signal CS. The temperature abnormality information signal CS output by the temperature information output circuit 330 is output from the acquired information selection circuit 300 and output from the head unit 20 via one terminal TMcs. In other words, one terminal TMcs of the head unit 20 outputs the temperature abnormality information signal CS from the head unit 20.

Here, an example of the information selection signal SEL generated by the acquired information selection control circuit 340 based on the drive data signal DI1 is described. FIG. 11 shows an example of the information selection signal SEL. The acquired information selection control circuit 340 analyzes the input drive data signal DI1, and thereby, specifies a signal for a request by the control circuit 100 of output from the individual information output circuit 320 and the temperature information output circuit 330. In response to the request from the control circuit 100, the acquired information selection control circuit 340 generates an information selection signal SEL containing 3-bit selection data SD [SD1, SD2, SD3] for controlling the multiplexer 322 of the individual information output circuit 320 and the multiplexer 332 of the temperature information output circuit 330.

When the drive data signal DI1 for requesting acquisition of information as to whether the temperature of the drive signal selection circuit 200 provided in the print head 22-1 is normal is input to the acquired information selection circuit 300, the acquired information selection control circuit 340 generates and outputs selection data SD [SD1, SD2, SD3]=[0, 0, 1] as the information selection signal SEL to the individual information output circuit 320 and the temperature information output circuit 330. When the selection data SD [SD1, SD2, SD3]=[0, 0, 1] is input, as shown in FIG. 11, the multiplexer 332 of the temperature information output circuit selects and outputs the temperature abnormality information signal CS2 output by the individual information output circuit 320 as the temperature abnormality information signal CS.

Concurrently, the same selection data SD [SD1, SD2, SD3]=[0, 0, 1] as that for the multiplexer 332 is input the multiplexer 322 of the individual information output circuit 320. Accordingly, as shown in FIG. 11, the multiplexer 322 selects and outputs the temperature state signal XHOT1 corresponding to the temperature of the drive signal selection circuit 200 of the print head 22-1 as the temperature abnormality information signal CS2. As a result, the acquired information selection circuit 300 outputs the temperature state signal XHOT1 corresponding to the temperature of the drive signal selection circuit 200 of the print head 22-1 as the temperature abnormality information signal CS.

When the drive data signal DI1 for requesting acquisition of information as to whether the temperature of the drive signal selection circuit 200 provided in the print head 22-2 is normal is input to the acquired information selection circuit 300, the acquired information selection control circuit 340 generates and outputs selection data SD [SD1, SD2, SD3]=[0, 1, 0] as the information selection signal SEL to the individual information output circuit 320 and the temperature information output circuit 330. When the selection data SD [SD1, SD2, SD3]=[0, 1, 0] is input, as shown in FIG. 11, the multiplexer 332 of the temperature information output circuit 330 selects and outputs the temperature abnormality information signal CS2 output by the individual information output circuit 320 as the temperature abnormality information signal CS.

Concurrently, the same selection data SD [SD1, SD2, SD3]=[0, 1, 0] as that for the multiplexer 332 is input to the multiplexer 322 of the individual information output circuit 320. Accordingly, as shown in FIG. 11, the multiplexer 322 selects and outputs the temperature state signal XHOT2 corresponding to the temperature of the drive signal selection circuit 200 of the print head 22-2 as the temperature abnormality information signal CS2. As a result, the acquired information selection circuit 300 outputs the temperature state signal XHOT2 corresponding to the temperature of the drive signal selection circuit 200 of the print head 22-2 as the temperature abnormality information signal CS.

When the drive data signal DI1 for requesting acquisition of information as to whether the temperature of the drive signal selection circuit 200 provided in the print head 22-3 is normal is input to the acquired information selection circuit 300, the acquired information selection control circuit 340 generates and selection data SD [SD1, SD2, SD3]=[0, 1, 1] as the information selection signal SEL to the individual information output circuit 320 and the temperature information output circuit 330. When the selection data SD [SD1, SD2, SD3]=[0, 1, 1] is input, as shown in FIG. 11, the multiplexer 332 of the temperature information output circuit 330 selects and outputs the temperature abnormality information signal CS2 output by the individual information output circuit 320 as the temperature abnormality information signal CS.

Concurrently, the same selection data SD [SD1, SD2, SD3]=[0, 1, 1] as that for the multiplexer 332 is input to the multiplexer 322 of the individual information output circuit 320. Accordingly, as shown in FIG. 11, the multiplexer 322 selects and outputs the temperature state signal XHOT3 corresponding to the temperature of the drive signal selection circuit 200 of the print head 22-3 as the temperature abnormality information signal CS2. As a result, the acquired information selection circuit 300 outputs the temperature state signal XHOT3 corresponding to the temperature of the drive signal selection circuit 200 of the print head 22-3 as the temperature abnormality information signal CS.

When the drive data signal DI1 for requesting acquisition of information as to whether the temperature of the drive signal selection circuit 200 provided in the print head 22-4 is normal is input to the acquired information selection circuit 300, the acquired information selection control circuit 340 generates and outputs selection data SD [SD1, SD2, SD3]=[1, 0, 0] as the information selection signal SEL to the individual information output circuit 320 and the temperature information output circuit 330. When the selection data SD [SD1, SD2, SD3]=[1, 0, 0] is input, as shown in FIG. 11, the multiplexer 332 of the temperature information output circuit 330 selects and outputs the temperature abnormality information signal CS2 output by the individual information output circuit 320 as the temperature abnormality information signal CS. Concurrently, the same selection data SD [SD1, SD2, SD3]=[1, 0, 0] as that for the multiplexer 332 is input to the multiplexer 322 of the individual information output circuit 320. Accordingly, as shown in FIG. 11, the multiplexer 322 selects and outputs the temperature state signal XHOT4 corresponding to the temperature of the drive signal selection circuit 200 of the print head 22-4 as the temperature abnormality information signal CS2. As a result, the acquired information selection circuit 300 outputs the temperature state signal XHOT4 corresponding to the temperature of the drive signal selection circuit 200 of the print head 22-4 as the temperature abnormality information signal CS.

When the drive data signal DI1 for requesting acquisition of information as to whether the temperature of the drive signal selection circuit 200 provided in the print head 22-5 is normal is input to the acquired information selection circuit 300, the acquired information selection control circuit 340 generates and outputs selection data SD [SD1, SD2, SD3]=[1, 0, 1] as the information selection signal SEL to the individual information output circuit 320 and the temperature information output circuit 330. When the selection data SD [SD1, SD2, SD3]=[1, 0, 1] is input, as shown in FIG. 11, the multiplexer 332 of the temperature information output circuit 330 selects and outputs the temperature abnormality information signal CS2 output by the individual information output circuit 320 as the temperature abnormality information signal CS. Concurrently, the same selection data SD [SD1, SD2, SD3]=[1, 0, 1] as that for the multiplexer 332 is input to the multiplexer 322 of the individual information output circuit 320. Accordingly, as shown in FIG. 11, the multiplexer 322 selects and outputs the temperature state signal XHOT5 corresponding to the temperature of the drive signal selection circuit 200 of the print head 22-5 as the temperature abnormality information signal CS2. As a result, the acquired information selection circuit 300 outputs the temperature state signal XHOT5 corresponding to the temperature of the drive signal selection circuit 200 of the print head 22-5 as the temperature abnormality information signal CS.

When the drive data signal DI1 for requesting acquisition of information as to whether the temperature of the drive signal selection circuit 200 provided in the print head 22-6 is normal is input to the acquired information selection circuit 300, the acquired information selection control circuit 340 generates and outputs selection data SD [SD1, SD2, SD3]=[1, 1, 0] as the information selection signal SEL, to the individual information output circuit 320 and the temperature information output circuit 330. When the selection data SD [SD1, SD2, SD3]=[1, 1, 0] is input, as shown in FIG. 11, the multiplexer 332 of the temperature information output circuit 330 selects and outputs the temperature abnormality information signal CS2 output by the individual information output circuit 320 as the temperature abnormality information signal CS. Concurrently, the same selection data SD [SD1, SD2, SD3]=[1, 1, 0] as that for the multiplexer 332 is input to the multiplexer 322 of the individual information output circuit 320. Accordingly, as shown in FIG. 11, the multiplexer 322 selects and outputs the temperature state signal XHOT6 corresponding to the temperature of the drive signal selection circuit 200 of the print head 22-6 as the temperature abnormality information signal CS2. As a result, the acquired information selection circuit 300 outputs the temperature state signal XHOT6 corresponding to the temperature of the drive signal selection circuit 200 of the print head 22-6 as the temperature abnormality information signal CS.

As described above, when the temperature information output circuit 330 outputs the temperature abnormality information signal CS2 as the temperature abnormality information signal CS, the information selection signal SEL output by the acquired information selection control circuit 340 selects one of the temperature state signals XHOT1 to XHOT6.

When the drive data signal DI1 for requesting acquisition of information as to whether all of the temperatures of the drive signal selection circuits 200 provided in the respective print heads 22-1 to 22-6 are normal is input to the acquired information selection circuit 300, the acquired information selection control circuit 340 generates and outputs selection data SD [SD1, SD2, SD3]=[1, 1, 1] as the information selection signal SEL to the individual information output circuit 320 and the temperature information output circuit 330. When the selection data SD [SD1, SD2, SD3]=[1, 1, 1] is input, as shown in FIG. 11, the multiplexer 332 of the temperature information output circuit 330 selects and outputs the temperature abnormality information signal CS1 output by the integrated information output circuit 310 as the temperature abnormality information signal CS. Concurrently, the integrated information output circuit 310 outputs the temperature abnormality information signal CS1 indicating whether all of the temperatures of the drive signal selection circuits 200 provided in the respective print heads 22-1 to 22-6 of the head unit 20 are normal. As a result, the acquired information selection circuit 300 outputs the temperature abnormality information signal CS1 according to information as to whether all of the temperatures of the drive signal selection circuits 200 provided in the respective print heads 22-1 to 22-6 are normal as the temperature abnormality information signal CS.

Further, the same selection data SD [SD1, SD2, SD3]=[1, 1, 1] as that for the multiplexer 332 is input to the multiplexer 322 of the individual information output circuit 320. Accordingly, as shown in FIG. 11, the multiplexer 322 does not select any of the temperature state signals XHOT1 to XHOT6 output by the print heads 22-1 to 22-6. That is, when the temperature information output circuit 330 outputs the temperature abnormality information signal CS1 as the temperature abnormality information signal CS, the information selection signal SEL output by the acquired information selection control circuit 340 does not select any of the temperature state signals XHOT1 to XHOT6.

Here, as shown in FIG. 11, when the acquired information selection control circuit 340 outputs the selection data SD [SD1, SD2, SD3]=[0, 0, 0] or the selection data SD [SD1, SD2, SD3]=[1, 1, 1] to the individual information output circuit 320 as the information selection signal SEL, the multiplexer 322 of the individual information output circuit 320 does not select any of the temperature state signals XHOT1 to XHOT6. Concurrently, the multiplexer 322 sets the output terminal that outputs the temperature abnormality information signal CS2 to a high-impedance state by electrically decoupling the plurality of input terminals to which the temperature state signals XHOT1 to XHOT6 are input and the output terminal that outputs the temperature abnormality information signal CS2. In this case, the multiplexer 322 may output a constant temperature abnormality information signal CS2 at a predetermined voltage value. Here, for example, the predetermined voltage value may be a voltage value of the power supply voltage of the multiplexer 322 or the ground potential.

Similarly, as shown in FIG. 11, when the acquired information selection control circuit 340 outputs the selection data SD [SD1, SD2, SD3]=[0, 0, 0] to the temperature information output circuit 330 as the information selection signal SEL, the multiplexer 332 of the temperature information output circuit 330 does not select the temperature abnormality information signal CS1 or the temperature abnormality information signal CS2. Concurrently, the multiplexer 332 sets the output terminal that outputs the temperature abnormality information signal CS2 to the high-impedance state by electrically decoupling of the input terminal to which the temperature abnormality information signal CS1 is input and the input terminal to which the temperature abnormality information signal CS2 is input, and the output terminal that outputs the temperature abnormality information signal CS. In this case, the multiplexer 332 may output a constant temperature abnormality information signal CS at a predetermined voltage value. Here, for example, the predetermined voltage value may be a voltage value of the power supply voltage of the multiplexer 332 or the ground potential.

As described above, in the acquired information selection circuit 300 of the first embodiment, the acquired information selection control circuit 340 generates the information selection signal SEL based on the drive data signal DI1, acquires information as to whether all of the temperatures of the drive signal selection circuits 200 provided in the respective print heads 22-1 to 22-6 are normal or information as to whether the respective temperatures of the drive signal selection circuits 200 provided in the respective print heads 22-1 to 22-6 are normal based on the information selection signal SEL, and outputs the information as the temperature abnormality information signal CS. The temperature abnormality information signal CS output by the acquired information selection circuit 300 is output from the head unit 20 via one terminal TMcs of the head unit 20.

Here, an optimum example of a determination method for determining the presence or absence of temperature abnormality of the drive signal selection circuit 200 provided in each of the print heads 22-1 to 22-6 using the acquired information selection circuit 300 having the above-described configuration is described.

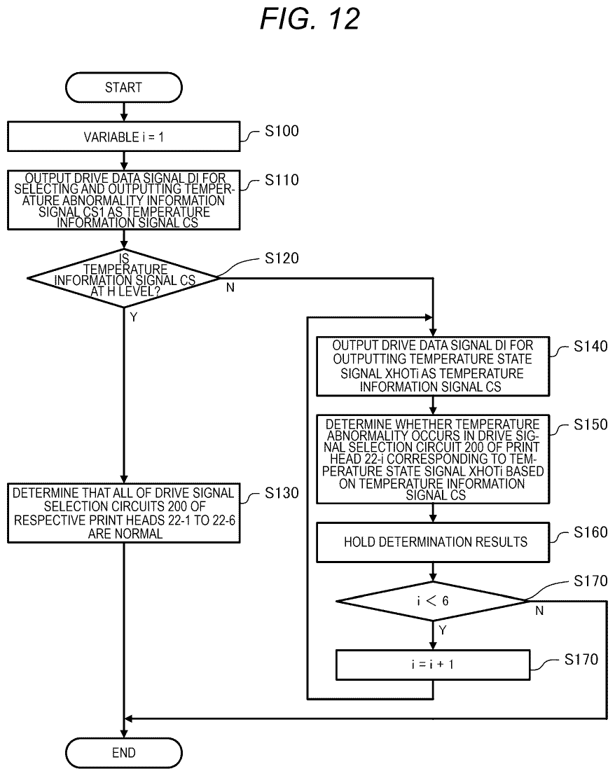

FIG. 12 shows an example of a determination method of the presence or absence of temperature abnormality of the drive signal selection circuit 200 provided in each of the print heads 22-1 to 22-6.

In the liquid ejection apparatus 1, when determination processing of the presence or absence of temperature abnormality of the drive signal selection circuit 200 provided in each of the print heads 22-1 to 22-6 is performed, the control circuit 100 assigns “1” to a variable i as an initial setting (step S100). Then, the control circuit 100 executes an integrated determination step of integrated determination of the presence or absence of abnormality in the print heads 22-1 to 22-6. Note that the determination processing of the presence or absence of temperature abnormality of the drive signal selection circuit 200 provided in each of the print heads 22-1 to 22-6 may be performed at any timing, for example, timing based on a user's request or timing including all periods during which the liquid ejection apparatus 1 is operating.

Specifically, the control circuit 100 selects the temperature abnormality information signal CS1 output by the integrated information output circuit 310, and generates and outputs the drive data signal DI1 to be output as the temperature abnormality information signal CS as the drive data signal DI1 for the acquired information selection control circuit 340 to output the selection data SD [SD1, SD2, SD3]=[1, 1, 1] as the information selection signal SEL (step S110). Thereby, the acquired information selection circuit 300 outputs the temperature abnormality information signal CS1 at the logic level that changes according to whether all of the temperatures of the drive signal selection circuits 200 provided in the respective print heads 22-1 to 22-6 of the head unit 20 are normal to the control circuit 100 as the temperature abnormality information signal CS.

The control circuit 100 determines whether all of the temperatures of the drive signal selection circuits 200 provided in the respective print heads 22-1 to 22-6 of the head unit 20 are normal, that is, whether temperature abnormality occurs in the head unit 20 according to the logic level of the input temperature abnormality information signal CS. Specifically, the control circuit 100 determines whether the logic level of the input temperature abnormality information signal CS is the H level (step S120). When the control circuit 100 determines that the logic level of the input temperature abnormality information signal CS is the H level (Y in step S120), the control circuit 100 determines that all of the temperatures of the drive signal selection circuits 200 provided in the respective print heads 22-1 to 22-6 of the head unit 20 are normal (step S130), and ends the determination process of the presence or absence of temperature abnormality of the drive signal selection circuits 200 provided in each of the print heads 22-1 to 22-6. Concurrently, the control circuit 100 may notify the user that all of the temperatures of the drive signal selection circuits 200 provided in the respective print heads 22-1 to 22-6 of the head unit 20 are normal through a notification unit (not shown).

On the other hand, when the control circuit 100 determines that the logic level of the input temperature abnormality information signal CS is not the H level (N in step S120), that is, when the control circuit 100 determines that the logic level of the input temperature abnormality information signal CS is the L level, the control circuit 100 determines that temperature abnormality occurs in the drive signal selection circuit 200 provided in any one of the print heads 22-1 to 22-6 of the head unit 20, and executes an individual determination step of individually determining the presence or absence of abnormality in the print heads 22-1 to 22-6.

In execution of the individual determination step, the control circuit 100 generates and outputs the drive data signal DI1 for the individual information output circuit 320 to select the temperature state signal XHOT1 and for the temperature information output circuit 330 to select and output the temperature abnormality information signal CS1 as the temperature abnormality information signal CS, that is, the drive data signal DI1 for the acquired information selection control circuit 340 to output the selection data SD [SD1, SD2, SD3]=[0, 0, 1] (step S140). Thereby, the acquired information selection circuit 300 outputs the temperature state signal XHOT1 corresponding to the temperature of the drive signal selection circuit 200 provided in the print head 22-1 of the head unit 20 to the control circuit 100 as the temperature abnormality information signal CS.

The control circuit 100 determines whether temperature abnormality occurs in the drive signal selection circuit 200 of the print head 22-1 corresponding to the temperature state signal XHOT1 based on the logic level of the input temperature abnormality information signal CS (step S150). Specifically, when the input temperature abnormality information signal CS is at the H level, the control circuit 100 determines that the temperature of the drive signal selection circuit 200 of the print head 22-1 corresponding to the temperature state signal XHOT1 is normal, and, when the input temperature abnormality information signal CS is at the L level, determines that the temperature of the drive signal selection circuit 200 of the print head 22-1 corresponding to the temperature state signal XHOT1 is abnormal. Then, the control circuit 100 holds the determination result (step S160).

Then, the control circuit 100 determines whether the variable i is less than 6 (step S170), and when the control circuit 100 determines that the variable i is less than 6 (Y in step S170), the control circuit 100 adds “1” to the variable i (step S180), and repeatedly executes the above-described steps S140 to S170. That is, the control circuit 100 controls the acquired information selection circuit 300 to sequentially output the temperature state signals XHOT2 to XHOT6 corresponding to the temperatures of the drive signal selection circuits 200 provided in the print heads 22-2 to 22-6 of the head unit 20 as the temperature abnormality information signals CS, and sequentially determines whether the temperatures of the drive signal selection circuits 200 of the print heads 22-2 to 22-6 corresponding to the temperature state signals XHOT2 to XHOT6 are normal based on the logic levels of the input temperature abnormality information signals CS and holds the determination results. In other words, in the individual determination step, the control circuit 100 individually determines whether the temperatures of the drive signal selection circuits 200 of the print heads 22-1 to 22-6 are normal, and holds the determination results.

Then, when the determinations as to whether the temperatures of the drive signal selection circuits 200 of the respective print heads 22-1 to 22-6 of the head unit 20 are completed, the control circuit 100 ends the determination processing of the presence or absence of temperature abnormality of the drive signal selection circuits 200 provided in the respective print heads 22-1 to 22-6. Concurrently, the control circuit 100 may notify the user of the held determination results through a notification unit (not illustrated).

In the liquid ejection apparatus 1 of the first embodiment, when the temperature abnormality information signal CS1 input as the temperature abnormality information signal CS contains abnormality information and is at the H level, the control circuit 100 acquires the temperature abnormality information signal CS2 as the temperature abnormality information signal CS, and specifies a part in which temperature abnormality occurs of the print heads 22-1 to 22-6 based on the temperature abnormality information signal CS2 as the temperature abnormality information signal CS. That is, when the temperature abnormality information signal CS1 contains abnormality information, the control circuit 100 specifies an abnormal part from the plurality of drive signal selection circuits 200 of the print heads 22-1 to 22-6 based on the temperature abnormality information signal CS2. In other words, the head unit 20 outputs the temperature abnormality information signal CS1 as the temperature abnormality information signal CS, when the output temperature abnormality information signal CS1 as the temperature abnormality information signal CS contains abnormality information and is at the H level, outputs the temperature abnormality information signal CS2 as the temperature abnormality information signal CS, and thereby, an abnormal part in which temperature abnormality occurs in the print heads 22-1 to 22-6 of the head unit 20 is specified.

Here, the ejection unit 600 of the print head 22-1 is an example of a first ejection unit, the piezoelectric element 60 provided in the ejection unit 600 of the print head 22-1 is an example of a first drive element, the drive signal selection circuit 200 of the print head 22-1 is an example of a first drive control circuit, and the temperature abnormality detection circuit 400 of the print head 22-1 is an example of a first temperature detection circuit. Further, the ejection unit 600 of the print head 22-2 is an example of a second ejection unit, the piezoelectric element 60 provided in the ejection unit 600 of the print head 22-2 is an example of a second drive element, the drive signal selection circuit 200 of the print head 22-2 is an example of a second drive control circuit, and the temperature abnormality detection circuit 400 of the print head 22-2 is an example of a second temperature detection circuit. Furthermore, the plurality of ejection units 600 of the head unit 20 including the print heads 22-1 and 22-2 are examples of a plurality of ejection units, the plurality of drive signal selection circuits 200 of the head unit 20 including the print heads 22-1 and 22-2 are examples of a plurality of drive control circuits, and the plurality of temperature abnormality detection circuits 400 of the head unit 20 including the print heads 22-1 and 22-2 are examples of a plurality of temperature detection circuits. In the multiplexer 322 of the individual information output circuit 320, the terminal to which the temperature state signal XHOT1 is input is an example of a first input terminal, the terminal to which the temperature state signal XHOT2 is input is an example of a second input terminal, the terminals to which the temperature state signals XHOT1 to XHOT6 are input are examples of a plurality of input terminals, and the terminal that outputs the temperature abnormality information signal CS2 is an example of a selection information output terminal.

Further, the temperature state signal XHOT1 is an example of a first state signal, the temperature state signal XHOT2 is an example of a second state signal, the temperature state signals XHOT1 to XHOT6 are examples of a plurality of detection results, the information selection signal SEL is an example of a selection signal, the signal selected by the information selection signal SEL of the temperature state signals XHOT1 to XHOT6 in the individual information output circuit 320 is an example of a selected detection result, and the signal not selected by the information selection signal SEL of the temperature state signals XHOT1 to XHOT6 in the individual information output circuit 320 is an example of a deselected detection result. The temperature abnormality information signal CS1 output by the integrated information output circuit 310 is an example of a first temperature abnormality information signal, the temperature abnormality information signal CS2 output by the individual information output circuit 320 is an example of a second temperature abnormality information signal, and the temperature abnormality information signal CS output by the temperature information output circuit 330 is an example of temperature abnormality information signal and a temperature information signal. The terminal TMcs for outputting the temperature abnormality information signal CS from the head unit 20 is an example of a temperature information output terminal.

### 1.7 Functions and Effects

As described above, the head unit 20 of the liquid ejection apparatus 1 of the first embodiment includes the integrated information output circuit 310 that outputs information signal the temperature abnormality CS1 corresponding to the temperature state signals XHOT1 to XHOT6 detected by the plurality of temperature abnormality detection circuits 400, the individual information output circuit 320 that outputs the temperature abnormality information signal CS2 corresponding to one signal selected from the temperature state signals XHOT1 to XHOT6 in response to the information selection signal SEL, and the temperature information output circuit 330 that outputs the temperature abnormality information signal CS corresponding to the temperature abnormality information signal CS1, the temperature abnormality information signal CS2, and the information selection signal SEL. Accordingly, the temperature information output circuit 330 can select and output the temperature abnormality information signal CS1 corresponding to the temperature state signals XHOT1 to XHOT6 detected by the plurality of temperature abnormality detection circuits 400 and the temperature abnormality information signal CS2 corresponding to the one signal selected from the temperature state signals XHOT1 to XHOT6 in response to the information selection signal SEL as the temperature abnormality information signal CS as one signal, and the head unit 20 can output the temperature abnormality information signal CS as the one signal via one terminal TMcs. That is, in the head unit 20 of the first embodiment, even when the head unit 20 includes the plurality of print heads 22-1 to 22-6, the detection result obtained by integration of the presence or absence of temperature abnormality of each of the plurality of print heads 22-1 to 22-6 and the detection result obtained by individual detection of the presence or absence of temperature abnormality of each of the plurality of print heads 22-1 to 22-6 can be output without increase of the terminal for outputting the detection result of the presence or absence of temperature abnormality of each of the print heads 22-1 to 22-6 and the signal line.

Further, in the head unit 20 of the first embodiment, when the temperature state signal XHOTi is selected in response to the information selection signal SEL, the individual information output circuit 320 electrically couples the input terminal to which the temperature state signal XHOTi is input and the output terminal that outputs the temperature abnormality information signal CS2, and electrically decouples the other input terminals than the input terminal to which the temperature state signal XHOTi is input and the output terminal that outputs the temperature abnormality information signal CS2. Thereby, the signal not selected in response to the information selection signal SEL has a reduced influence on the output temperature abnormality information signal CS2, and the accuracy of the detection result of individual detection of the presence or absence of the temperature abnormality of each of the plurality of print heads 22-1 to 22-6 output by the temperature information output circuit 330 is improved. Here, the individual information output circuit 320 includes the multiplexer 322 as shown in the head unit 20 of the first embodiment, and thereby, the complexity of the circuit configuration of the individual information output circuit 320 can be reduced and downsizing of the individual information output circuit 320 can be achieved.

Furthermore, in the head unit 20 of the first embodiment, when the information selection signal SEL does not select any of the temperature state signals XHOT1 to XHOT6, the individual information output circuit 320 electrically decouples from which the terminals the temperature state signals XHOT1 to XHOT6 are input to the individual information output circuit 320 and the terminal from which the temperature abnormality information signal CS2 is output from the individual information output circuit 320. In this case, when the information selection signal SEL does not select any of the temperature state signals XHOT1 to XHOT6, the individual information output circuit 320 may output a constant signal with a predetermined voltage value as the temperature abnormality information signal CS2. Thereby, even when the signal quality of the information selection signal SEL input to the individual information output circuit 320 is lower due to the influence of disturbance noise or the like, an unintended false operation in the head unit 20 can be reduced according to the output of the individual information output circuit 320.

In the head unit 20 of the first embodiment, the integrated information output circuit 310 includes the AND circuit 312 when the temperature abnormality detection circuit 400 of the print head 22-i outputs the temperature state signal XHOTi being at the L level when detecting a temperature abnormality of the drive signal selection circuit 200 of the print head 22-i and the temperature state signal XHOTi being at the H level when not detecting the temperature abnormality of the drive signal selection circuit 200 of the print head 22-i. Thereby, the complexity of the circuit configuration of the integrated information output circuit 310 can be reduced and downsizing of the integrated information output circuit 310 can be achieved.

### 2. Second Embodiment

Next, a liquid ejection apparatus 1 and a head unit 20 according to a second embodiment will be described. For description of the liquid ejection apparatus 1 and the head unit 20 of the second embodiment, the same configurations as those of the liquid ejection apparatus 1 and the head unit 20 of the first embodiment have the same signs and the description thereof is omitted or simplified.

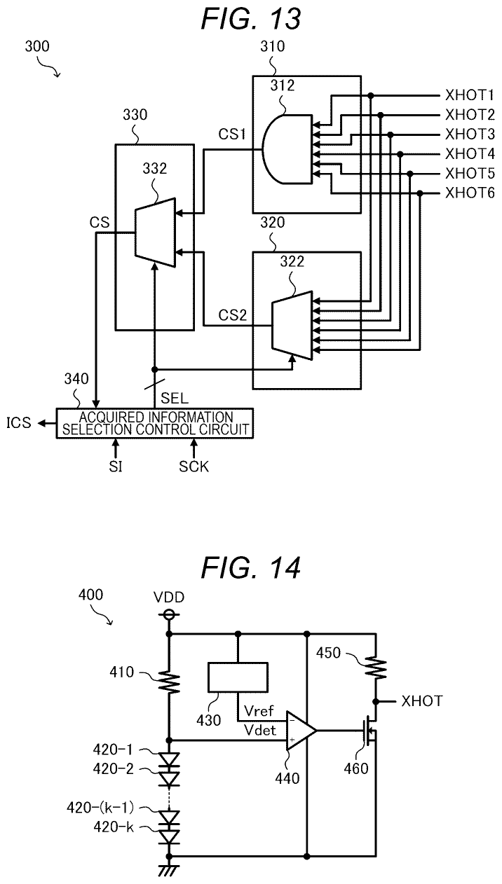

FIG. 13 shows an example of a configuration of an acquired information selection circuit 300 of the second embodiment. As shown in FIG. 13, the liquid ejection apparatus 1 and the head unit 20 of the second embodiment are different from the liquid ejection apparatus 1 and the head unit 20 of the first embodiment in that the temperature abnormality information signal CS output by the temperature information output circuit 330 is input to the acquired information selection control circuit 340. Here, the acquired information selection control circuit 340 generates and outputs the information selection signal SEL based on the analysis result of the command contained in the drive data signal DI1 and the input temperature abnormality information signal CS to the individual information output circuit 320 and the temperature information output circuit 330, and generates a temperature information signal ICS based on the temperature abnormality information signal CS and outputs the generated temperature information signal ICS instead of the temperature abnormality information signal CS from the head unit 20 via the terminal TMcs. This is also different from the liquid ejection apparatus 1 and the head unit 20 of the first embodiment.

Specifically, in the liquid ejection apparatus 1 and the head unit 20 of the second embodiment, when the drive data signal DI1 for requesting acquisition of information as to whether all of the temperatures of the drive signal selection circuits 200 provided in the respective print heads 22-1 to 22-6 are normal is input to the acquired information selection control circuit 340, the acquired information selection control circuit 340 generates and outputs an information selection signal SEL containing selection data SD [SD1, SD2, SD3] corresponding to the content shown in FIG. 11 to the individual information output circuit 320 and the temperature information output circuit 330. Thereby, the temperature abnormality information signal CS indicating whether all of the temperatures of the drive signal selection circuits 200 provided in the respective print heads 22-1 to 22-6 of the head unit 20 are normal is input to the acquired information selection control circuit 340. The acquired information selection control circuit 340 determines whether all of the temperatures of the drive signal selection circuits 200 provided in the respective print heads 22-1 to 22-6 are normal according to the logic level of the input temperature abnormality information signal CS, and generates the temperature information signal ICS according to the determination result. Then, the acquired information selection control circuit 340 outputs the generated temperature information signal ICS from the head unit 20 via the terminal TMcs.

In the liquid ejection apparatus 1 and the head unit 20 of the second embodiment, when the drive data signal DI1 for requesting acquisition of information as to whether the temperature of the drive signal selection circuit 200 provided in the print head 22-i is normal is input to the acquired information selection control circuit 340, the acquired information selection control circuit 340 generates and outputs the information selection signal SEL containing the selection data SD [SD1, SD2, SD3] corresponding to the content shown in FIG. 11 to the individual information output circuit 320 and the temperature information output circuit 330. Thereby, the temperature abnormality information signal CS indicating whether the temperature of the drive signal selection circuit 200 provided in the print head 22-i of the head unit 20 is normal is input to the acquired information selection control circuit 340. The acquired information selection control circuit 340 determines whether the temperature of the drive signal selection circuit 200 provided in the print head 22-i is normal according to the logic level of the input temperature abnormality information signal CS, and generates the temperature information signal ICS according to the determination result. Then, the acquired information selection control circuit 340 outputs the generated temperature information signal ICS from the head unit 20 via the terminal TMcs.

That is, in the liquid ejection apparatus 1 and the head unit 20 of the second embodiment, the acquired information selection control circuit 340 generates the information selection signal SEL corresponding to the input drive data signal DI1, and acquires the temperature abnormality information signal CS output by the temperature information output circuit 330. Then, the acquired information selection control circuit 340 determines whether the temperature of the drive signal selection circuit 200 provided in each of the print heads 22-1 to 22-6 of the head unit 20 indicated by the drive data signal DI1 is normal according to the acquired temperature abnormality information signal CS, and outputs the temperature information signal ICS according to the determination result from the head unit 20 via the terminal TMcs. Here, the temperature information signal ICS output by the acquired information selection control circuit 340 may be a signal at the same logic level as that of the temperature abnormality information signal CS, or may be a predetermined command indicating whether the temperature of the drive signal selection circuit 200 provided in each of the print heads 22-1 to 22-6 is normal.

Further, in the liquid ejection apparatus 1 and the head unit 20 of the second embodiment, when the drive data signal DI1 for requesting the determination processing of the presence or absence of temperature abnormality of the drive signal selection circuit 200 provided in each of the print heads 22-1 to 22-6 is input to the acquired information selection control circuit 340, the acquired information selection control circuit 340 executes the processing of the determination method of the presence or absence of the temperature abnormality of the drive signal selection circuit 200 provided in each of the print heads 22-1 to 22-6 shown in FIG. 12 in place of the control circuit 100.

Specifically, when the drive data signal DI1 for requesting the determination processing of the presence or absence of temperature abnormality of the drive signal selection circuit 200 provided in each of the print heads 22-1 to 22-6 is input to the acquired information selection control circuit 340, the acquired information selection control circuit 340 executes the integrated determination step of integrated determination of the presence or absence of abnormality of the above-described print heads 22-1 to 22-6 in place of the control circuit 100. When determining that all of the temperatures of the drive signal selection circuits 200 provided in the respective print heads 22-1 to 22-6 of the head unit 20 are normal in the integrated determination step, the acquired information selection control circuit 340 generates the temperature information signal ICS containing information indicating that all of the temperatures of the drive signal selection circuits 200 provided in the respective print heads 22-1 to 22-6 of the head unit 20 are normal, and outputs the generated temperature information signal ICS from the head unit 20 via the terminal TMcs.

On the other hand, in the integrated determination step, when the acquired information selection control circuit 340 determines that temperature abnormality occurs in the drive signal selection circuit 200 provided in any one of the print heads 22-1 to 22-6 of the head unit 20, the acquired information selection control circuit 340 determines that temperature abnormality occurs in the drive signal selection circuit 200 provided in any one of the print heads 22-1 to 22-6 of the head unit 20, and executes the individual determination step of individually determining the presence or absence of abnormality in the print heads 22-1 to 22-6. In the individual determination step, the acquired information selection control circuit 340 individually determines whether the temperatures of the drive signal selection circuits 200 provided in the respective print heads 22-1 to 22-6 are normal, and holds the determination results. Then, when the determinations as to whether the temperatures of the drive signal selection circuits 200 of the respective print heads 22-1 to 22-6 of the head unit 20 are completed, the acquired information selection control circuit 340 generates the temperature information signal ICS containing the information of the determination results of the presence or absence of temperature abnormality of the drive signal selection circuit 200 provided in the respective print heads 22-1 to 22-6 to be held, and outputs the generated temperature information signal ICS from the head unit 20 via the terminal TMcs.

That is, in the liquid ejection apparatus 1 and the head unit 20 of the second embodiment, when the temperature abnormality information signal CS1 input as the temperature abnormality information signal CS contains abnormality information and is at the H level, the acquired information selection control circuit 340 acquires the temperature abnormality information signal CS2 as the temperature abnormality information signal CS and specifies the part in which temperature abnormality occurs in the print heads 22-1 to 22-6 based on the temperature abnormality information signal CS2 as the temperature abnormality information signal CS. Then, the acquired information selection control circuit 340 generates the temperature information signal ICS containing the information of the part in which the temperature abnormality occurs in the specified print heads 22-1 to 22-6, and outputs the generated temperature information signal ICS from the head unit 20 via the terminal TMcs. In other words, when the temperature abnormality information signal CS1 contains abnormality information, the acquired information selection control circuit 340 specifies an abnormal part from the plurality of drive signal selection circuits 200 of the respective print heads 22-1 to 22-6 based on the temperature abnormality information signal CS2.

In the liquid ejection apparatus 1 and the head unit 20 of the second embodiment, the processing load in the control circuit 100 can be reduced in addition to the functions and effects of the liquid ejection apparatus 1 and the head unit 20 of the first above-described embodiment.

Here, in the liquid ejection apparatus 1 and the head unit 20 of the second embodiment, the acquired information selection control circuit 340 is an example of an abnormal part specification circuit, and the temperature information signal ICS output by the acquired information selection control circuit 340 is an example of a temperature information signal.

### 3. Third Embodiment

Next, a liquid ejection apparatus 1 and a head unit 20 according to a third embodiment will be described. For description of the liquid ejection apparatus 1 and the head unit 20 of the third embodiment, the same configurations as those of the liquid ejection apparatuses 1 and the head units 20 of the first embodiment and the second embodiment have the same signs and the description thereof is omitted or simplified. In the liquid ejection apparatus 1 of the third embodiment, the logic levels of the temperature state signals XHOT1 to XHOT6 output by the temperature abnormality detection circuit 400 of the respective print heads 22-1 to 22-6 are different from those of the liquid ejection apparatus 1 and the head unit 20 of the first embodiment.

FIG. 14 shows an example of a configuration of temperature abnormality detection circuit 400 according to the third embodiment. As shown in FIG. 14, in the temperature abnormality detection circuit 400 of the third embodiment, the voltage signal Vdet having a voltage value that changes depending on the temperature is input to the positive-side input terminal of the comparator 440, and the voltage signal Vref output by the reference voltage generation circuit 430 is input to the negative-side input terminal of the comparator 440. Accordingly, in the temperature abnormality detection circuit 400 of the third embodiment, the comparator 440 outputs a signal at the L level of the ground potential when the voltage value of the voltage signal Vdet is smaller than the voltage value of the voltage signal Vref and at the H level of the voltage signal VDD when the voltage value of the voltage signal Vdet is larger than the voltage value of the voltage signal Vref.

Then, when the signal output by the comparator 440 is input to the gate terminal of the transistor 460, the temperature abnormality detection circuit 400 outputs the H-level temperature state signal XHOT when the temperature of the drive signal selection circuit 200 is out of the temperature range in which the drive signal selection circuit 200 can stably operate, and outputs the L-level temperature state signal XHOT when the temperature of the drive signal selection circuit 200 is within the temperature range in which the drive signal selection circuit 200 can stably operate. In other words, the temperature abnormality detection circuit 400 of the third embodiment outputs the H-level temperature state signal XHOT when the temperature of the corresponding drive signal selection circuit 200 is abnormal, and outputs the temperature state signal L-level XHOT when the temperature of the corresponding drive signal selection circuit 200 is normal.

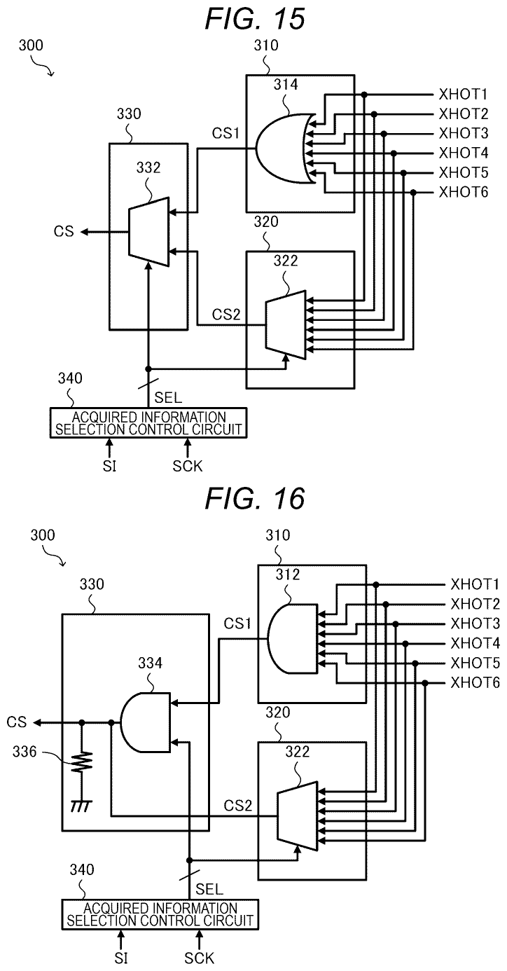

FIG. 15 shows an example of a configuration of an acquired information selection circuit 300 according to the third embodiment. As shown in FIG. 15, in the liquid ejection apparatus 1 and the head unit 20 of the third embodiment, the integrated information output circuit 310 outputs the temperature abnormality information signal CS1 corresponding to the temperature state signals XHOT1 to XHOT6 as the detection results of the presence or absence of temperature abnormality of the plurality of drive signal selection circuits 200 respectively detected by the plurality of temperature abnormality detection circuits 400 of the head unit 20.

Specifically, the integrated information output circuit 310 includes an OR circuit 314. The temperature state signals XHOT1 to XHOT6 output by the respective print heads 22-1 to 22-6 are input to the OR circuit 314. Then, the OR circuit 314 outputs a signal according to the logic level of the input temperature state signals XHOT1 to XHOT6. The signal output by the OR circuit 314 is output from the integrated information output circuit 310 as the temperature abnormality information signal CS1.

As described above, in the liquid ejection apparatus 1 of the third embodiment, the temperature state signals XHOT1 to XHOT6 output by the respective print heads 22-1 to 22-6 are at the L level when the temperature of the corresponding drive signal selection circuit 200 is normal, and at the H level when the temperature of the corresponding drive signal selection circuit 200 is abnormal. When the temperature state signals XHOT1 to XHOT6 are input to the OR circuit 314, the integrated information output circuit 310 outputs the temperature abnormality information signal CS1 at the L level when all of the temperatures of the drive signal selection circuit 200 provided in the respective print heads 22-1 to 22-6 are normal and at the H level when abnormality occurs in a temperature of at least one of the drive signal selection circuits 200 provided in the respective print heads 22-1 to 22-6.

That is, in the liquid ejection apparatus 1 of the third embodiment, the temperature abnormality detection circuit 400 of the print head 22-i outputs the temperature state signal XHOTi at the H level when detecting temperature abnormality of the drive signal selection circuit 200 of the print head 22-i and at the L level when detecting temperature abnormality of the drive signal selection circuit 200 of the print head 22-i as a detection result of the presence or absence of temperature abnormality of the drive signal selection circuit 200 of the print head 22-i. Here, the integrated information output circuit 310 includes the OR circuit 314. Accordingly, when all of the temperature state signals XHOT1 to XHOT6 indicate normality, the integrated information output circuit 310 outputs the L-level temperature abnormality information signal CS1 as the temperature abnormality information signal CS1 containing normality information, and, when at least one of the temperature state signals XHOT1 to XHOT6 indicates abnormality, outputs the H-level temperature abnormality information signal CS1 as the temperature abnormality information signal CS1 containing abnormality information.

In other words, the integrated information output circuit 310 of the third embodiment also integrates information as to whether the temperatures of the drive signal selection circuits 200 provided in the respective print heads 22-1 to 22-6 of the head unit 20 are normal, and outputs the temperature abnormality information signal CS1 at the logic level that changes according to whether all of the temperatures of the drive signal selection circuits 200 provided in the respective print heads 22-1 to 22-6 of the head unit 20 are normal. The integrated information output circuit 310 of the third embodiment may include a circuit equivalent to the OR circuit instead of the OR circuit 314.

The liquid ejection apparatus 1 of the third embodiment having the above-described configuration exerts the functions and effects of the liquid ejection apparatus 1 and the head unit 20 of the above-described first embodiment.

### 4. Fourth Embodiment

Next, a liquid ejection apparatus 1 and the head unit 20 according to a fourth embodiment will be described. For description of the liquid ejection apparatus 1 and the head unit 20 of the fourth embodiment, the same configurations as those of the liquid ejection apparatuses 1 and the head units 20 of the first embodiment, the second embodiment, and the third embodiment have the same signs and the description thereof is omitted or simplified. In the liquid ejection apparatus 1 of the fourth embodiment, the configuration of the temperature information output circuit 330 of the acquired information selection circuit 300 is different from those of the liquid ejection apparatuses 1 and the head units 20 of the first embodiment, the second embodiment, and the third embodiment.

FIG. 16 shows an example of a configuration of an acquired information selection circuit 300 of the fourth embodiment. The temperature information output circuit 330 in the liquid ejection apparatus 1 and the head unit 20 of the fourth embodiment outputs the temperature abnormality information signal CS corresponding to the temperature abnormality information signal CS1, the temperature abnormality information signal CS2, and the information selection signal SEL.

Specifically, the temperature information output circuit 330 includes an AND circuit 334 and a resistor 336. The temperature abnormality information signal CS1 output by the integrated information output circuit 310 and the information selection signal SEL output by the acquired information selection control circuit 340 are input to the AND circuit 334. When all of the logic levels of the selection data SD [SD1, SD2, SD3] input as the information selection signals SEL are at the H level and the selection data SD [SD1, SD2, SD3]=[1, 1, 1], the AND circuit 334 outputs a signal according to the logic level of the temperature abnormality information signal CS1, and, when at least one of the logic levels of the selection data SD [SD1, SD2, SD3] input as the information selection signals SEL is at the L level, does not output a signal according to the logic level of the temperature abnormality information signal CS1 and the output terminal is set at high impedance. The temperature abnormality information signal CS2 output by the individual information output circuit 320 is input to the output terminal of the AND circuit 334, and one end of the resistor 336 is coupled thereto. The ground potential is supplied to the other end of the resistor 336.

The temperature information output circuit 330 in the liquid ejection apparatus 1 and the head unit 20 of the fourth embodiment having the above-described configuration outputs a signal of the output terminal of the AND circuit 334, that is, a signal at one end of the resistor 336 as the temperature abnormality information signal CS.

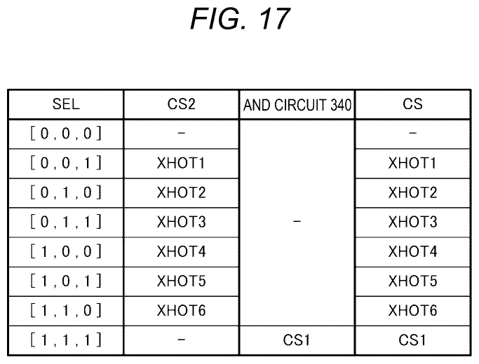

Here, a relationship between the temperature abnormality information signal CS output by the temperature information output circuit 330 and the information selection signal SEL output by the acquired information selection control circuit 340 provided in the liquid ejection apparatus 1 and the head unit 20 of the fourth embodiment is described. FIG. 17 shows the relationship between the temperature abnormality information signal CS output by the temperature information output circuit 330 of the fourth embodiment and the information selection signal SEL.

When the drive data signal DI1 for requesting acquisition of information as to whether the temperature of the drive signal selection circuit 200 provided in the print head 22-1 is normal is input to the acquired information selection circuit 300, the acquired information selection control circuit 340 generates and outputs selection data SD [SD1, SD2, SD3]=[0, 0, 1] as the information selection signal SEL to the individual information output circuit 320 and the temperature information output circuit 330. When the selection data SD [SD1, SD2, SD3]=[0, 0, 1] is input, the AND circuit 334 of the temperature information output circuit 330 controls the output terminal at high impedance. Concurrently, the same selection data SD [SD1, SD2, SD3]=[0, 0, 1] as that for the AND circuit 334 is input to the multiplexer 322 of the individual information output circuit 320. Accordingly, as shown in FIG. 17, the multiplexer 322 selects and outputs the temperature state signal XHOT1 corresponding to the temperature of the drive signal selection circuit 200 of the print head 22-1 as the temperature abnormality information signal CS2. The temperature state signal XHOT1 output by the multiplexer 322 is supplied to the output terminal of the AND circuit 334 of the temperature information output circuit 330, and thereby, the acquired information selection circuit 300 outputs the temperature state signal XHOT1 corresponding to the temperature of the drive signal selection circuit 200 of the print head 22-1 as the temperature abnormality information signal CS.

When the drive data signal DI1 for requesting acquisition of information as to whether the temperature of the drive signal selection circuit 200 provided in the print head 22-2 is normal is input to the acquired information selection circuit 300, the acquired information selection control circuit 340 generates and outputs selection data SD [SD1, SD2, SD3]=[0, 1, 0] as the information selection signal SEL to the individual information output circuit 320 and the temperature information output circuit 330. When the selection data SD [SD1, SD2, SD3]=[0, 1, 0] is input, the AND circuit 334 of the temperature information output circuit 330 controls the output terminal at high impedance. Concurrently, the same selection data SD [SD1, SD2, SD3]=[0, 1, 0] as that for the AND circuit 334 is input to the multiplexer 322 of the individual information output circuit 320. Accordingly, as shown in FIG. 17, the multiplexer 322 selects and outputs the temperature state signal XHOT2 corresponding to the temperature of the drive signal selection circuit 200 of the print head 22-2 as the temperature abnormality information signal CS2. The temperature state signal XHOT2 output by the multiplexer 322 is supplied to the output terminal of the AND circuit 334 of the temperature information output circuit 330, and thereby, the acquired information selection circuit 300 outputs the temperature state signal XHOT2 corresponding to the temperature of the drive signal selection circuit 200 of the print head 22-2 as the temperature abnormality information signal CS.

When the drive data signal DI1 for requesting acquisition of information as to whether the temperature of the drive signal selection circuit 200 provided in the print head 22-3 is normal is input to the acquired information selection circuit 300, the acquired information selection control circuit 340 generates and selection data SD [SD1, SD2, SD3]=[0, 1, 1] as the information selection signal SEL to the individual information output circuit 320 and the temperature information output circuit 330. When the selection data SD [SD1, SD2, SD3]=[0, 1, 1] is input, the AND circuit 334 of the temperature information output circuit 330 controls the output terminal at high impedance. Concurrently, the same selection data SD [SD1, SD2, SD3]=[0, 1, 1] as that for the AND circuit 334 is input to the multiplexer 322 of the individual information output circuit 320. Accordingly, as shown in FIG. 17, the multiplexer 322 selects and outputs the temperature state signal XHOT3 corresponding to the temperature of drive signal selection circuit 200 of the print head 22-3 as the temperature abnormality information signal CS2. The temperature state signal XHOT3 output by the multiplexer 322 is supplied to the output terminal of the AND circuit 334 of the temperature information output circuit 330, and thereby, the acquired information selection circuit 300 outputs the temperature state signal XHOT3 corresponding to the temperature of the drive signal selection circuit 200 of the print head 22-3 as the temperature abnormality information signal CS.

When the drive data signal DI1 for requesting acquisition of information as to whether the temperature of the drive signal selection circuit 200 provided in the print head 22-4 is normal is input to the acquired information selection circuit 300, the acquired information selection control circuit 340 generates and outputs selection data SD [SD1, SD2, SD3]=[1, 0, 0] as the information selection signal SEL to the individual information output circuit 320 and the temperature information output circuit 330. When the selection data SD [SD1, SD2, SD3]=[1, 0, 0] is input, the AND circuit 334 of the temperature information output circuit 330 controls the output terminal at high impedance. Concurrently, the same selection data SD [SD1, SD2, SD3]=[1, 0, 0] as that for the AND circuit 334 is input to the multiplexer 322 of the individual information output circuit 320. Accordingly, as shown in FIG. 17, the multiplexer 322 selects and outputs the temperature state signal XHOT4 corresponding to the temperature of the drive signal selection circuit 200 of the print head 22-4 as the temperature abnormality information signal CS2. The temperature state signal XHOT4 output by the multiplexer 322 is supplied to the output terminal of the AND circuit 334 of the temperature information output circuit 330, and thereby, the acquired information selection circuit 300 outputs the temperature state signal XHOT4 corresponding to the temperature of the drive signal selection circuit 200 of the print head 22-4 as the temperature abnormality information signal CS.

When the drive data signal DI1 for requesting acquisition of information as to whether the temperature of the drive signal selection circuit 200 provided in the print head 22-5 is normal is input to the acquired information selection circuit 300, the acquired information selection control circuit 340 generates and outputs selection data SD [SD1, SD2, SD3]=[1, 0, 1] as the information selection signal SEL to the individual information output circuit 320 and the temperature information output circuit 330. When the selection data SD [SD1, SD2, SD3]=[1, 0, 1] is input, the AND circuit 334 of the temperature information output circuit 330 controls the output terminal at high impedance. Concurrently, the same selection data SD [SD1, SD2, SD3]=[1, 0, 1] as that for the AND circuit 334 is input to the multiplexer 322 of the individual information output circuit 320. Accordingly, as shown in FIG. 17, the multiplexer 322 selects and outputs the temperature state signal XHOT5 corresponding to the temperature of the drive signal selection circuit 200 of the print head 22-5 as the temperature abnormality information signal CS2. The temperature state signal XHOT5 output by the multiplexer 322 is supplied to the output terminal of the AND circuit 334 of the temperature information output circuit 330, and thereby, the acquired information selection circuit 300 outputs the temperature state signal XHOT5 corresponding to the temperature of the drive signal selection circuit 200 of the print head 22-5 as the temperature abnormality information signal CS.

When the drive data signal DI1 for requesting acquisition of information as to whether the temperature of the drive signal selection circuit 200 provided in the print head 22-6 is normal is input to the acquired information selection circuit 300, the acquired information selection control circuit 340 generates and outputs selection data SD [SD1, SD2, SD3]=[1, 1, 0] as the information selection signal SEL, to the individual information output circuit 320 and the temperature information output circuit 330. When the selection data SD [SD1, SD2, SD3]=[1, 1, 0] is input, the AND circuit 334 of the temperature information output circuit 330 controls the output terminal at high impedance. Concurrently, the same selection data SD [SD1, SD2, SD3]=[1, 1, 0] as that for the AND circuit 334 is input to the multiplexer 322 of the individual information output circuit 320. Accordingly, as shown in FIG. 17, the multiplexer 322 selects and outputs the temperature state signal XHOT6 corresponding to the temperature of the drive signal selection circuit 200 of the print head 22-6 as the temperature abnormality information signal CS2. The temperature state signal XHOT6 output by the multiplexer 322 is supplied to the output terminal of the AND circuit 334 of the temperature information output circuit 330, and thereby, the acquired information selection circuit 300 outputs the temperature state signal XHOT6 corresponding to the temperature of the drive signal selection circuit 200 of the print head 22-6 as the temperature abnormality information signal CS.

As described above, when the temperature information output circuit 330 outputs the temperature abnormality information signal CS2 as the temperature abnormality information signal CS, the information selection signal SEL output by the acquired information selection control circuit 340 selects one of the temperature state signals XHOT1 to XHOT6.

When the drive data signal DI1 for requesting acquisition of information as to whether all of the temperatures of the drive signal selection circuits 200 provided in the respective print heads 22-1 to 22-6 are normal is input to the acquired information selection circuit 300, the acquired information selection control circuit 340 generates and outputs selection data SD [SD1, SD2, SD3]=[1, 1, 1] as the information selection signal SEL to the individual information output circuit 320 and the temperature information output circuit 330. When the selection data SD [SD1, SD2, SD3]=[1, 1, 1] is input, the AND circuit 334 of the temperature information output circuit 330 outputs a signal at a logic level that changes based on the temperature abnormality information signal CS1 output by the integrated information output circuit 310 and equivalent to the temperature abnormality information signal CS1. Concurrently, the integrated information output circuit 310 outputs the temperature abnormality information signal CS1 indicating whether all of the temperatures of the drive signal selection circuits 200 provided in the respective print heads 22-1 to 22-6 of the head unit 20 are normal. As a result, the acquired information selection circuit 300 outputs the temperature abnormality information signal CS1 according to information as to whether all of the temperatures of the drive signal selection circuits 200 provided in the respective print heads 22-1 to 22-6 are normal as the temperature abnormality information signal CS.

Further, the same selection data SD [SD1, SD2, SD3]=[1, 1, 1] as that for the AND circuit 334 is input to the multiplexer 322 of the individual information output circuit 320. Accordingly, as shown in FIG. 17, the multiplexer 322 does not select any of the temperature state signals XHOT1 to XHOT6 output by the print heads 22-1 to 22-6. Concurrently, the output terminal of the multiplexer 322 is controlled at high impedance. That is, in the liquid ejection apparatus 1 and the head unit 20 of the fourth embodiment, when the information selection signal SEL does not select any of the temperature state signals XHOT1 to XHOT6, the temperature information output circuit 330 outputs the temperature abnormality information signal CS1 as the temperature abnormality information signal CS.

The liquid ejection apparatus 1 of the fourth embodiment having the above-described configuration exerts the functions and effects of the liquid ejection apparatus 1 and the head unit 20 of the above-described first embodiment.

Although the embodiments and the modified examples are described as above, the present disclosure is not limited to these embodiments and can be implemented in various configurations without departing from the gist thereof. For example, the above-described embodiments can appropriately be combined.

The present disclosure includes substantially the same configurations (e.g., configurations having the same functions, methods, and results, and configurations having the same purposes and effects) as the configurations described in the embodiments. Further, the present disclosure includes configurations obtained by replacement of non-essential portions of the configurations described in the embodiments. Furthermore, the present disclosure includes configurations that exert the same functions and effects or configurations that can achieve the same purposes as those of the configurations described in the embodiments. In addition, the present disclosure includes configurations obtained by addition of a known technique to the configurations described in the embodiments.

The following configurations are derived from the above-described embodiments.

A head unit according to an aspect of the present disclosure includes a plurality of ejection units including a first ejection unit that contains a first drive element and ejects a liquid by driving the first drive element, and a second ejection unit that contains a second drive element and ejects the liquid by driving the second drive element, a plurality of drive control circuits including a first drive control circuit that controls driving of the first drive element and a second drive control circuit that controls driving of the second drive element, a plurality of temperature detection circuits including a first temperature detection circuit that detects presence or absence of temperature abnormality of the first drive control circuit and a second temperature detection circuit that detects presence or absence of temperature abnormality of the second drive control circuit, an integrated information output circuit outputting a first temperature abnormality information signal according to a plurality of detection results detected by the plurality of temperature detection circuits, an individual information output circuit outputting a second temperature abnormality information signal according to a selected detection result obtained by selecting one from the plurality of detection results in response to a selection signal, a temperature information output circuit outputting a temperature abnormality information signal corresponding to the first temperature abnormality information signal, the second temperature abnormality information signal, and the selection signal, and one temperature information output terminal outputting a temperature information signal based on the temperature abnormality information signal.

The head unit includes the integrated information output circuit outputting the first temperature abnormality information signal according to the plurality of detection results detected by the plurality of temperature detection circuits and the temperature information output circuit outputting the temperature abnormality information signal corresponding to the first temperature abnormality information signal, the second temperature abnormality information signal, and the selection signal, and thereby, even when the plurality of ejection units including the first ejection unit that contains the first drive element and ejects the liquid by driving the first drive element and the second ejection unit that contains the second drive element and ejects the liquid by driving the second drive element, the plurality of drive control circuits including the first drive control circuit that controls driving of the first drive element and the second drive control circuit that controls driving of the second drive element, and the plurality of temperature detection circuits including the first temperature detection circuit that detects presence or absence of temperature abnormality of the first drive control circuit and the second temperature detection circuit that detects presence or absence of temperature abnormality of the second drive control circuit, the temperature information signal based on the temperature abnormality information signal can be output from the one temperature information output terminal. Accordingly, even when the head unit has a plurality of ejection units provided in different print heads, temperature abnormality of the plurality of print heads can be individually acquired without an increase in number of wirings and terminals.

In the head unit according to the aspect, when all of the plurality of detection results indicate normality, the integrated information output circuit may output the first temperature abnormality information signal containing normality information, and when at least one of the plurality of detection results indicates abnormality, output the first temperature abnormality information signal containing abnormality information.

In the head unit, the integrated information output circuit can integrate the presence or absence of the temperature abnormality by the plurality of temperature detection circuits including the first temperature detection circuit that detects the presence or absence of the temperature abnormality of the first drive control circuit and the second temperature detection circuit that detects the presence or absence of the temperature abnormality of the second drive control circuit, and acquire and determine the integrated information in a shorter time.

In the head unit according to the aspect, when the selected detection result indicates normality, the individual information output circuit may output the second temperature abnormality information signal containing normality information regardless of a deselected detection result deselected from the plurality of detection results in response to the selection signal, and when the selected detection result indicates abnormality, output the second temperature abnormality information signal containing abnormality information regardless of the deselected detection result.

In the head unit, the individual information output circuit can individually acquire and determine the presence or absence of the temperature abnormality detected by the plurality of temperature detection circuits including the first temperature detection circuit that detects the presence or absence of the temperature abnormality of the first drive control circuit and the second temperature detection circuit that detects the presence or absence of the temperature abnormality of the second drive control circuit, and thereby, can individually acquire the presence or absence of the temperature abnormality in the respective plurality of drive control circuits including the presence or absence of the temperature abnormality of the first drive control circuit that controls driving of the first drive element and the presence or absence of the temperature abnormality of the second drive control circuit that controls driving of the second drive element.

In the head unit according to the aspect, the individual information output circuit includes a plurality of input terminals containing a first input terminal to which a detection result of the first temperature detection circuit is input and a second input terminal to which a detection result of the second temperature detection circuit is input, and a selection information output terminal that outputs the second temperature abnormality information signal, and when the detection result of the first temperature detection circuit is selected as the selected detection result, may electrically couple the first input terminal and the selection information output terminal and electrically decouple the other input terminals than the first input terminal of the plurality of input terminals and the selection information output terminal.

In the head unit, the contribution of the signal not selected as the selected detection result, but input to the input terminal to the detection result of the first temperature detection circuit selected as the selected detection result may be reduced.

In the head unit according to the aspect, the individual information output circuit may be a multiplexer selecting one of the plurality of detection results in response to the selection signal.

This head unit does not require a complicated circuit, and downsizing of the head unit can be achieved.

In the head unit according to the aspect, when the selection signal does not select any of the plurality of detection results, the individual information output circuit may electrically decouple the plurality of input terminals and the selection information output terminal.

In the head unit, when disturbance noise or the like is superimposed on the selection signal, a false operation may be reduced.

In the head unit according to the aspect, when the selection signal does not select any of the plurality of detection results, the individual information output circuit may output a signal having a predetermined voltage value as the second temperature abnormality information signal.

In the head unit, when disturbance noise or the like is superimposed on the selection signal, a false operation may be reduced.

In the head unit according to the aspect, when the first temperature detection circuit outputs a first state signal at a low level when detecting temperature abnormality of the first drive control circuit and at a high level when not detecting temperature abnormality of the first drive control circuit as a detection result of presence or absence of temperature abnormality of the first drive control circuit, and the second temperature detection circuit outputs a second state signal at the low level when detecting temperature abnormality of the second drive control circuit and at the high level when not detecting temperature abnormality of the second drive control circuit as a detection result of presence or absence of temperature abnormality of the second drive control circuit, the integrated information output circuit may include an AND circuit or a circuit equivalent to an AND circuit to which the first state signal and the second state signal are input.

This head unit does not require a complicated circuit, and downsizing of the head unit can be achieved.

In the head unit according to the aspect, when the first temperature detection circuit outputs a first state signal at a high level when detecting temperature abnormality of the first drive control circuit and at a low level when not detecting temperature abnormality of the first drive control circuit as a detection result of presence or absence of temperature abnormality of the first drive control circuit, and the second temperature detection circuit outputs a second state signal at the high level when detecting temperature abnormality of the second drive control circuit and at the low level when not detecting temperature abnormality of the second drive control circuit as a detection result of presence or absence of temperature abnormality of the second drive control circuit, the integrated information output circuit may include an OR circuit or a circuit equivalent to an OR circuit to which the first state signal and the second state signal are input.

This head unit does not require a complicated circuit, and downsizing of the head unit can be achieved.

In the head unit according to the aspect, when the selection signal does not select any of the plurality of detection results, the temperature information output circuit may output the first temperature abnormality information signal as the temperature abnormality information signal.

In the head unit according to the aspect, the temperature information output circuit may select and output the first temperature abnormality information signal or the second temperature abnormality information signal in response to the selection signal as the temperature abnormality information signal.

In the head unit according to the aspect, when the temperature information output circuit outputs the second temperature abnormality information signal as the temperature abnormality information signal, the selection signal may select one of the plurality of detection results, and when the temperature information output circuit outputs the first temperature abnormality information signal as the temperature abnormality information signal, the selection signal may not select any of the plurality of detection results.

The head unit according to the aspect may include an abnormal part specification circuit, when the first temperature abnormality information signal contains abnormality information, specifying an abnormal part from the plurality of drive control circuits based on the second temperature abnormality information signal.

In the head unit, the plurality of drive control circuits in which abnormality occurs can be efficiently specified.

What is claimed is:

1. A head unit comprising:
a plurality of ejection units including a first ejection unit that contains a first drive element and ejects a liquid by driving the first drive element, and a second ejection unit that contains a second drive element and ejects the liquid by driving the second drive element;
a plurality of drive control circuits including a first drive control circuit that controls driving of the first drive element and a second drive control circuit that controls driving of the second drive element;
a plurality of temperature detection circuits including a first temperature detection circuit that detects presence or absence of temperature abnormality of the first drive control circuit and a second temperature detection circuit that detects presence or absence of temperature abnormality of the second drive control circuit;
an integrated information output circuit outputting a first temperature abnormality information signal according to a plurality of detection results detected by the plurality of temperature detection circuits;
an individual information output circuit outputting a second temperature abnormality information signal according to a selected detection result obtained by selecting one from the plurality of detection results in response to a selection signal;
a temperature information output circuit outputting a temperature abnormality information signal corresponding to the first temperature abnormality information signal, the second temperature abnormality information signal, and the selection signal; and
one temperature information output terminal outputting a temperature information signal based on the temperature abnormality information signal.

2. The head unit according to claim 1, wherein
when all of the plurality of detection results indicate normality, the integrated information output circuit outputs the first temperature abnormality information signal containing normality information, and when at least one of the plurality of detection results indicates abnormality, outputs the first temperature abnormality information signal containing abnormality information.

3. The head unit according to claim 1, wherein
when the selected detection result indicates normality, the individual information output circuit outputs the second temperature abnormality information signal containing normality information regardless of a deselected detection result deselected from the plurality of detection results in response to the selection signal, and when the selected detection result indicates abnormality, outputs the second temperature abnormality information signal containing abnormality information regardless of the deselected detection result.

4. The head unit according to claim 1, wherein
the individual information output circuit includes a plurality of input terminals containing a first input terminal to which a detection result of the first temperature detection circuit is input and a second input terminal to which a detection result of the second temperature detection circuit is input, and a selection information output terminal that outputs the second temperature abnormality information signal, and when the detection result of the first temperature detection circuit is selected as the selected detection result, electrically couples the first input terminal and the selection information output terminal and electrically decouples the other input terminals than the first input terminal of the plurality of input terminals and the selection information output terminal.

5. The head unit according to claim 4, wherein
the individual information output circuit is a multiplexer selecting one of the plurality of detection results in response to the selection signal.

6. The head unit according to claim 4, wherein
when the selection signal does not select any of the plurality of detection results, the individual information output circuit electrically decouples the plurality of input terminals and the selection information output terminal.

7. The head unit according to claim 6, wherein
when the selection signal does not select any of the plurality of detection results, the individual information output circuit outputs a signal having a predetermined voltage value as the second temperature abnormality information signal.

8. The head unit according to claim 1, wherein
when the first temperature detection circuit outputs a first state signal at a low level when detecting temperature abnormality of the first drive control circuit and at a high level when not detecting temperature abnormality of the first drive control circuit asa detection result of presence or absence of temperature abnormality of the first drive control circuit, and the second temperature detection circuit outputs a second state signal at the low level when detecting temperature abnormality of the second drive control circuit and at the high level when not detecting temperature abnormality of the second drive control circuit as a detection result of presence or absence of temperature abnormality of the second drive control circuit, the integrated information output circuit includes an AND circuit or a circuit equivalent to an AND circuit to which the first state signal and the second state signal are input.

9. The head unit according to claim 1, wherein
when the first temperature detection circuit outputs a first state signal at a high level when detecting temperature abnormality of the first drive control circuit and at a low level when not detecting temperature abnormality of the first drive control circuit as detection result of presence or absence of temperature abnormality of the first drive control circuit, and the second temperature detection circuit outputs a second state signal at the high level when detecting temperature abnormality of the second drive control circuit and at the low level when not detecting temperature abnormality of the second drive control circuit as a detection result of presence or absence of temperature abnormality of the second drive control circuit, the integrated information output circuit includes an OR circuit or a circuit equivalent to an OR circuit to which the first state signal and the second state signal are input.

10. The head unit according to claim 1, wherein
when the selection signal does not select any of the plurality of detection results, the temperature information output circuit outputs the first temperature abnormality information signal as the temperature abnormality information signal.

11. The head unit according to claim 1, wherein
the temperature information output circuit selects and outputs the first temperature abnormality information signal or the second temperature abnormality information signal in response to the selection signal as the temperature abnormality information signal.

12. The head unit according to claim 11, wherein
when the temperature information output circuit outputs the second temperature abnormality information signal as the temperature abnormality information signal, the selection signal selects one of the plurality of detection results, and when the temperature information output circuit outputs the first temperature abnormality information signal as the temperature abnormality information signal, the selection signal does not select any of the plurality of detection results.

13. The head unit according to claim 1, further comprising an abnormal part specification circuit, when the first temperature abnormality information signal contains abnormality information, specifying an abnormal part from the plurality of drive control circuits based on the second temperature abnormality information signal.
